(19) United States
(12) Patent Application Publication
(10) Pub. No.: US 2024/0299789 A1
(43) Pub. Date: Sep. 12, 2024

(54) DEVICE, SYSTEM AND METHOD FOR REMOTE FIREFIGHTING

(71) Applicant: Fero International Inc., Hamilton (CA)

(72) Inventor: Vincenzo DiCristofaro, Burlington (CA)

(21) Appl. No.: 18/579,962

(22) PCT Filed: Jul. 18, 2022
(86) PCT No.: PCT/CA2022/051110

§ 371 Date: Jan. 17, 2024

Related U.S. Application Data
(60) Provisional application No. 63/223,017, filed on Jul. 18, 2021.

(51) Int. Cl. A62C 35/02; A62C 3/02; A62C 5/02

(52) U.S. Cl. CPC A62C 35/023; A62C 5/022; A62C 3/0292

(57) ABSTRACT

Firefighting devices and associated methods and systems for firefighting are described where the firefighting devices generally have a housing: at least one tank disposed in the housing and containing source material for a firefighting agent: a propellant system that is contained within the housing and operatively coupled to the at least one tank for deployment of the firefighting agent: a nozzle that is coupled to the propellant system for receiving and dispensing the firefighting agent: and a control unit that is coupled to the propellant system configured to autonomously control the firefighting device by activating the propellant system to discharge the firefighting agent through the nozzle to a portion of an operational region of the firefighting device based on analysis of sensor data obtained for a portion of the operational region or an adjacent area outside of the operational region or receipt of a signal from another device.

### CROSS-REFERENCE TO RELATED APPLICATION

This application claims the benefit of U.S. Provisional Patent Application No. 63/223,017 filed Jul. 18, 2021; the entire contents of U.S. Provisional Patent Application No. 63/223,017 is hereby incorporated herein in its entirety.

### FIELD

Various embodiments are described herein that generally relate to devices, systems and methods for firefighting using at least one firefighting device that may be portable, semi-portable or fixed and monitored remotely and locally.

### BACKGROUND

The following paragraphs are provided by way of background to the present disclosure. They are not, however, an admission that anything discussed therein is prior art or part of the knowledge of persons skilled in the art.

Wildfires are becoming more problematic as they are not only increasing in number every year, but the wildfire season is also increasing in time duration. For example, in the western United States, the wildfire season has increased in length from about 5 months in the 1970s to more than about 7 months in 2020. Also, the number of large wildfires (e.g., larger than 1,100 acres) has increased from an average of about 140 per year in the 1980's to about 160 per year in the 1990's to about 250 per year in the first decade of the 21^{st} century.

While the threat and intensity of wildfires has increased over the years, improvements to the tools and protection that are available to firefighters have not kept pace. For example, firefighters today have to dig holes and cover themselves with fire retardant blankets so they can take refuge in case a wildfire grows quickly out of control and rapidly approaches the firefighters. Such blankets will not provide protection if heavy objects that fall due to a fire were to fall on the firefighters. Accordingly, firefighters are routinely placed in harm's way, which may lead to firefighters losing their lives or developing serious health problems due to severe smoke inhalation or serious burns, for example.

In addition, fighting wildfires is challenging since wildfires can rapidly grow and also change direction. Accordingly, changing firefighting tactics and redeploying firefighting assets in a suitably timely manner is important. However, conventionally, wildfires are assessed sporadically by helicopter surveillance due to high costs which impacts the accuracy in determining the hottest areas of the wildfires or speed when determining when wildfires change in direction. Therefore, there is a lag in redeploying firefighting assets using conventional techniques and this lag may limit the ability to quickly and successfully fight certain areas of the wildfire which may change in intensity and/or direction more quickly and may therefore be more dangerous.

### SUMMARY OF VARIOUS EMBODIMENTS

Various embodiments of portable devices as well as systems and methods for fighting fires, such as wildfires, forest fires, industrial fires (mines, petrochemical, etc.), house fires, and fires involving any type of building or structure as well as for protecting roadways, escape routes, stationary buildings or other objects which may be of extreme important from external fire sources, are described herein.

In one broad aspect, in accordance with the teachings herein, there is provided an autonomous firefighting device, wherein the device comprises: a housing; at least one tank disposed within the housing, the at least one tank containing source material for a firefighting agent; a propellant system that is contained within the housing and operatively coupled to the at least one tank for deployment of the firefighting agent; a nozzle that is coupled to the propellant system for receiving and dispensing the firefighting agent; and a control unit that is coupled to the propellant system configured to autonomously control the firefighting device by activating the propellant system to discharge the firefighting agent through the nozzle to a portion of an operational region of the firefighting device based on analysis of sensor data obtained for a portion of the operational region or an adjacent area outside of the operational region or receipt of a signal from another device.

In at least one embodiment, the housing comprises surfaces that are made of fire-retardant material, are covered by fire retardant fabric or are covered by a fire retardant coating.

In at least one embodiment, the device further comprises: a memory for storing program instructions for one or more control programs; a temperature sensor for measuring temperature data for the operational region; and the control unit has a processor that, upon executing the one or more control programs, is configured to generate and send the control signal to deploy the firefighting agent when the measured temperature exceeds a temperature threshold or a fire front of the fire is less than a predetermined distance threshold from the firefighting device based on analysis performed by the processor or analysis performed by a drone.

In at least one embodiment, the temperature sensor is mounted on a portion of the nozzle or another portion of the firefighting device.

In at least one embodiment, the device further comprises: a moveable mount that is attached to the nozzle; and at least one actuator that is operatively coupled to the moveable mount; wherein the processor is communicatively coupled to the at least one actuator to send an actuator control signal to control the at least one actuator to move the moveable mount to move a tip of the nozzle during use.

In at least one embodiment, the moveable mount is adapted to move in a horizontal and/or vertical manner and the processor is configured to control the at least one actuator to move the moveable mount and the nozzle in a movement pattern that is selected from a plurality of stored predetermined movement patterns or received from an operator or other device.

In at least one embodiment, the movement pattern is selected from the stored predetermined movement patterns based on a characteristic of the fire including a hottest region of a fire, a leading edge of fire growth, a location that the fire is moving towards, an area where there is a fire fuel source and/or an area of fastest movement of the fire.

In at least one embodiment, the movement pattern is selected by performing correlations between the stored predetermined movement patterns and locations of the hottest regions of the fire to select the predetermined movement pattern that has a highest correlation with the locations of the hottest regions of the fire.

In at least one embodiment, the moveable mount is adapted to move in a horizontal and/or vertical manner and the processor is configured to determine a hottest area of a fire in the operational region from temperature data of the operational region and send the actuator control signal to the at least one actuator to move the moveable mount so that the tip of the nozzle is directed to the hottest area of the fire.

In at least one embodiment, the device further comprises communication hardware that is communicatively coupled to the processor and the processor is configured to transmit the measured temperatures to a remote computing device for monitoring any fires in the proximal region.

In at least one embodiment, the device further comprises a camera that is communicatively coupled to the processor, wherein the processor is configured to obtain images of the operational region and/or a farther adjacent region to the operational region and transmit the images to the remote computing device.

In at least one embodiment, the camera is mounted to the nozzle or another portion of the device.

In at least one embodiment, the camera is a thermal camera, a color camera and/or a white light camera.

In at least one embodiment, the device further comprises a positioning unit that is communicatively coupled to the processor and is configured to determine a location of the device, and the processor is configured to transmit the location of the device to the remote computing device.

In at least one embodiment, the device further comprises a wind sensor that is communicatively coupled to the processor and is configured for measuring wind direction and/or wind magnitude data for the operational region and/or a farther adjacent region to the operational region, wherein the processor is configured to transmit the wind direction and/or wind magnitude data to the remote computing device.

In at least one embodiment, the processor is configured to adjust an output setting of the nozzle to widen or narrow a spray pattern for the firefighting agent based on the measured wind direction and/or wind magnitude data.

In at least one embodiment, the device further comprises an air quality sensor meter that is communicatively coupled to the processor and is configured for measuring air quality data for the operational region and/or a farther adjacent region to the operational region, wherein the processor is configured to transmit the quality data to the remote computing device.

In at least one embodiment, the housing comprises one or more panels made of steel and having a fire-retardant coating and/or one or more panels made of fire rated fire resistant porous cement, ceramic boards or carbon-fiber.

In at least one embodiment, the one or more panels are removably mounted onto the housing to allow for maintenance or replacement of a given panel that has been damaged.

In at least one embodiment, the device further comprises an upper surface having posts that are adapted to releasably engage channels on a bottom of another firefighting device to allow for stacking multiple firefighting devices on top of one another.

In at least one embodiment, the device further comprises a cover that is operatively mounted to the housing, the cover being extendable from a closed position to an open position in which the cover is extended to the ground and is adjacent to upper and side portions of the device to provide an enclosure for at least one person for protection from fire.

In at least one embodiment, the cover has a pleated structure to allow for expansion.

In at least one embodiment, the cover is made from fire retardant material or has a fire-retardant coating.

In at least one embodiment, wherein the device further comprises an additional nozzle that is coupled to the propellant system for receiving and deploying the firefighting agent.

In at least one embodiment, the device comprises doors disposed at a top surface of the housing, an additional actuator for moving the additional nozzle and a valve between the additional nozzle and the propellant system and the additional nozzle has a storage position where it is disposed under the doors and an operating position when the doors are opened, the additional actuator being configured to raise the additional nozzle above the top surface of the housing and the valve is opened to allow the firefighting agent to travel to the additional nozzle.

In at least one embodiment, wherein the device further comprises a sensor that is configured to detect when the cover is deployed and the device is configured to generate an alert signal when the cover is deployed and transmit the alert signal to a remote device including a command center device, and/or a mobile device of a firefighter.

In at least one embodiment, the device is configured to send a location signal to the remote device to provide a location of the device when the cover is deployed.

In at least one embodiment, the firefighting agent comprises foam and the propellant system comprises a pressurized gas.

In at least one embodiment, the foam is created from a combination of source material for the firefighting agent, compressed gas and optionally water.

In at least one embodiment, the gas is an inert gas that it is non-

combustible and/or non-flammable.

In at least one embodiment, the propellant system comprises canisters of compressed gas and a controllable valve that when moved to an open position results in the firefighting agent being propelled to the nozzle for discharge.

In at least one embodiment, the firefighting agent is water and the propellant system comprises an air pump for discharging the water through the nozzle.

In at least one embodiment, the device further comprises an indicator on an upper surface thereof for indicating a wall of the device where the nozzle is mounted.

In at least one embodiment, the device further includes a drone that is deployed during use for providing surveillance of the operational region and/or a farther adjacent region of the device or a control signal to the device for automated deployment of the firefighting agent.

In at least one embodiment, the device includes bay doors on a portion of the housing for allowing the drone to lift-off and land and a mount located within the housing for storing the drone.

In at least one embodiment, the device includes a first interior frame that is coupled to the housing, a second interior frame that is pivotally connected to the first interior frame for pivoting about a first horizontal axis and a mount that is pivotally connected to the second interior frame for pivoting about a second horizontal axis that is perpendicular to the first pivot axis where the mount provides a surface for housing the drone such that the drone is horizontally level after deployment of the device.

In at least one embodiment, the drone is configured to obtain image data, analyze the image data to determine a location of a fire in the operational region and send the control signal to the device to deploy the firefighting agent to the location of the fire in the operation region.

In at least one embodiment, the drone is configured to obtain image data, analyze the image data to determine a location of operational region that a fire front is moving towards and send the control signal to the device to deploy the firefighting agent to the location of the operational region that the fire front is moving towards.

In at least one embodiment, the drone is configured to send data to the device and the device is configured to adjust a position of the nozzle during use based on the data from the drone.

In at least one embodiment, the drone is configured to send data to a remote operator and the device is configured to receive control signals from the remote operator to adjust a position of the nozzle during use.

In at least one embodiment, the device comprises: an outer frame upon which the housing is mounted; and a suspension assembly that is coupled with the outer frame to provide shock absorption when the device is deployed or when the device experiences an impact during use.

In at least one embodiment, the suspension assembly comprises a set of shock absorbers that are disposed within leg frames of the outer frame, the shock absorbers each having one end coupled to the outer frame and another end coupled to leg posts that slidably move in the leg frame.

In at least one embodiment, the leg posts have a slot that is engaged by a post connected to the leg frames for limiting a linear range of motion for the leg post.

In at least one embodiment, the device comprises feet that are pivotally connected at a lower portion of the leg posts.

In at least one embodiment, the device comprises quick connect couplings for the at least one tank and the propellant system to allow for quick refiling of source material for the firefighting agent and a compressed gas used by the propellant system.

In at least one embodiment, the device comprises quick connect couplings to connect the at least one tank to an exterior source that provides source material for the firefighting agent during deployment of the firefighting agent.

In at least one embodiment, the device further comprises at least one additional nozzle that is mounted at a first lateral side wall, a second lateral side wall and/or a rear wall, wherein the at least one additional nozzle is coupled to the propellant system and the at least one tank via a multi-port valve that is controllable to selectively provide the firefighting agent to the at least one additional nozzle that is oriented towards a direction of the fire.

In at least one embodiment, the device is operable in one of an autonomous mode, a remote control mode and/or a manual control mode, wherein during the remote control mode and the manual control mode control signals are provided by a human operator.

In another broad aspect, in accordance with the teachings herein, there is provided at least one embodiment of a method for operating one of the firefighting devices described herein, wherein the method comprises: measuring temperature of a portion of an operational region or a farther adjacent region to the portion of the operational region of the firefighting device; comparing the measured temperature to a temperature threshold; and autonomously discharging the firefighting agent from the nozzle of the firefighting device towards the portion of the operating region when the measured temperature exceeds the temperature threshold.

In at least one embodiment, the method comprises moving the nozzle in a vertical and/or horizontal manner during discharge of the firefighting agent.

In at least one embodiment, the method comprises determining a hottest area of a fire in the proximal region from temperature data of the proximal region controlling movement of the nozzle so that a tip of the nozzle is directed to the hottest area of the fire.

In at least one embodiment, the method comprises determining when there is a fire in the operational region based on temperature data of the operational region, selecting a movement pattern for the nozzle, and moving a tip of the nozzle according to the selected movement pattern.

In at least one embodiment, the movement pattern is selected from a plurality of stored predetermined movement patterns based on a characteristic of the fire including a hottest region of a fire, a leading edge of fire growth, a location that the fire is moving towards, an area where there is a fire fuel source and/or an area of fastest movement of the fire.

In at least one embodiment, the movement pattern is selected by performing correlations between stored predetermined movement patterns and locations of the hottest regions of the fire to select the stored predetermined movement pattern that has a highest correlation with the locations of the hottest regions of the fire.

In at least one embodiment, the method comprises monitoring the operation of the firefighting device at a remote computing device.

In at least one embodiment, the method comprises storing and/or transmitting the measured temperatures to the remote computing device.

In at least one embodiment, the method comprises obtaining images of the operational region and/or the farther adjacent region, and storing and/or transmitting the images to the remote computing device.

In at least one embodiment, the method comprises determining a location of the firefighting device and storing and/or transmitting the location to the remote computing device.

In at least one embodiment, the method comprises measuring wind direction and/or wind magnitude data for the operational region and/or the farther adjacent region, and storing and/or transmitting the wind direction and/or wind magnitude data to the remote computing device.

In at least one embodiment, the method comprises measuring air quality data for the operational region and/or the farther adjacent region, and storing and/or transmitting the air quality data to the remote computing device.

In another broad aspect, in accordance with the teachings herein, there is provided at least one embodiment of a system for fighting fire in a region, wherein the system comprises a plurality of firefighting devices that are defined according to any suitable embodiments described herein; a remote computing device that comprises: a memory for storing program instructions for a firefighting monitor/control program; communications hardware for receiving data from the plurality of firefighting devices; a processor that is communicatively coupled to the memory and the transceiver, the processor when executing the software instructions being configured to receive and display the data received from the plurality of firefighting devices.

In at least one embodiment, the processor is configured to generate a map of the region and display at least some of the data received from the plurality of firefighting devices on the map or from drones associated with the firefighting devices.

In at least one embodiment, the data comprises location data and the processor is configured to generate the map of the region including the locations of the plurality of firefighting devices.

In at least one embodiment, the data comprises temperature data and the processor is configured to generate the map of the region including the temperature data at the locations of the plurality of firefighting devices.

In at least one embodiment, the data comprises wind direction and wind magnitude data and the processor is configured to generate the map of the region including the wind direction and wind magnitude data at the locations of the plurality of firefighting devices.

In at least one embodiment, the data comprises air quality data and the processor is configured to generate the map of the region including the air quality data at the locations of the plurality of firefighting devices.

In at least one embodiment, the data is received periodically, and the processor is configured to update the generated map of the region with the periodically received data.

In at least one embodiment, the data is received in real time and the processor is configured to update the generated map of the region with the received data in real time.

In another broad aspect, in accordance with the teachings herein, there is provided at least one embodiment of a firefighting device, wherein the device comprises: a housing; at least one tank disposed within the housing, the at least one tank containing source material for a firefighting agent; a propellant system that is operatively coupled to the at least one tank for aiding in discharging the firefighting agent; a nozzle that is coupled to the propellant system for receiving and deploying the firefighting agent; a temperature sensor that is configured to obtain temperature data of an operational region of the firefighting device; and a processor that is operatively coupled to the temperature sensor, the propellant system and the nozzle, wherein during use the processor is configured to determine when there is a fire in an operational region of the device based on the temperature data, determine a hottest region of the fire, and send control signals to deploy the firefighting agent and to direct a tip of the nozzle to the hottest region of the fire.

In another broad aspect, in accordance with the teachings herein, there is provided at least one embodiment of a firefighting device, wherein the device comprises a housing; at least one tank disposed within the housing, the at least one tank containing source material for a firefighting agent; a propellant system that is operatively coupled to the at least one tank for aiding in discharging the firefighting agent; a nozzle that is coupled to the propellant system for receiving and deploying the firefighting agent; a temperature sensor that is configured to obtain temperature data of an operational region of the firefighting device; and a processor that is operatively coupled to the temperature sensor, the propellant system and the nozzle, wherein during use the processor is configured to determine when there is a fire in an operational region of the device based on the temperature data, obtain a movement pattern for the nozzle, and send control signals to move deploy the firefighting agent and move a tip of the nozzle according to the determined movement pattern.

In at least one embodiment, the device further comprises a memory that has a plurality of movement patterns stored thereon and the processor is operatively coupled to the memory and is configured to determine the movement pattern from one of the plurality of movement patterns based on a characteristic of the fire.

In at least one embodiment, the processor is configured to obtain the movement pattern for the nozzle from control signals that are received from a human operator.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIGS. 1A-1F show front perspective, rear perspective, top, front, side and cross-sectional end views, respectively, of an example embodiment of a firefighting device in accordance with the teachings herein.

FIG. 1G shows a cross-sectional view of another example

embodiment of a firefighting device in accordance with the teachings herein.

FIG. 1H shows another example embodiment of a firefighting device in accordance with the teachings herein.

FIG. 1I shows a magnified view cross-sectional view of a portion of the suspension assembly of the firefighting device of FIG. 1H.

FIG. 1J shows a magnified view cross-sectional view of a portion of the suspension assembly of the firefighting device of FIG. 1H.

FIGS. 2A-2B shows a right rear perspective view and a left rear perspective view with a partial cutout, respectively, of another example embodiment of a firefighting device in accordance with the teachings herein.

FIG. 2C shows a series of images depicting the canopy at various stages of deployment.

FIG. 2D shows an example of stacking one firefighting device on top of another and with the canopy being deployed for the bottommost firefighting device.

FIG. 2E shows a left rear perspective view of another example embodiment of a firefighting device in accordance with the teachings herein.

FIG. 3A shows a perspective view of an example embodiment of a compressed air foam system that may be used by the firefighting device in accordance with the teachings herein.

FIG. 3B shows a perspective view of an example embodiment of a nozzle assembly, piping, electronic and communication components that may be used by the firefighting device in accordance with the teachings herein.

FIG. 4 shows a block diagram of an example embodiment of a control unit and various hardware elements that may be used by the firefighting device in accordance with the teachings herein.

FIG. 5 shows a flow chart of an example embodiment of a method of

operating a firefighting device in accordance with the teachings herein.

FIG. 6 shows an example of a firefighting device during operation.

FIG. 7A shows an example of an infrared image that may be used by the firefighting device during operation.

FIG. 7B shows an example of a grid on an infrared image that may be used for automatic deployment of the firefighting agent during operation of the firefighting device.

FIG. 8 shows an image of an example deployment of several firefighting devices for fighting fire during a wildfire.

FIG. 9 shows an example embodiment of a firefighting system that incorporates a plurality of firefighting devices.

FIG. 10 shows an example image generated by the firefighting system of FIG. 9.

FIG. 11 shows a flowchart of an example embodiment of a method of operating a firefighting device that contains a drone as described in accordance with the teachings herein.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element such as a pipe, valve, chamber and the like, depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

The example embodiments of the devices, systems, or methods described in accordance with the teachings herein are generally implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, one or more sensors, and the like depending on the implementation of the hardware.

It should also be noted that some elements that are used to implement at least part of the embodiments described herein may be implemented via software that is written in a high-level procedural language such as object-oriented programming. The program code may be written in C⁺⁺, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

In accordance with the teachings herein, there are provided various embodiments of devices, systems and methods that may be used for remote firefighting. For example, the various embodiments described herein may be used for firefighting any type of fire including, but not limited to, wildfires, forest fires, industrial fires (mines, petrochemical, etc.), house fires, and fires involving any type of building or structure.

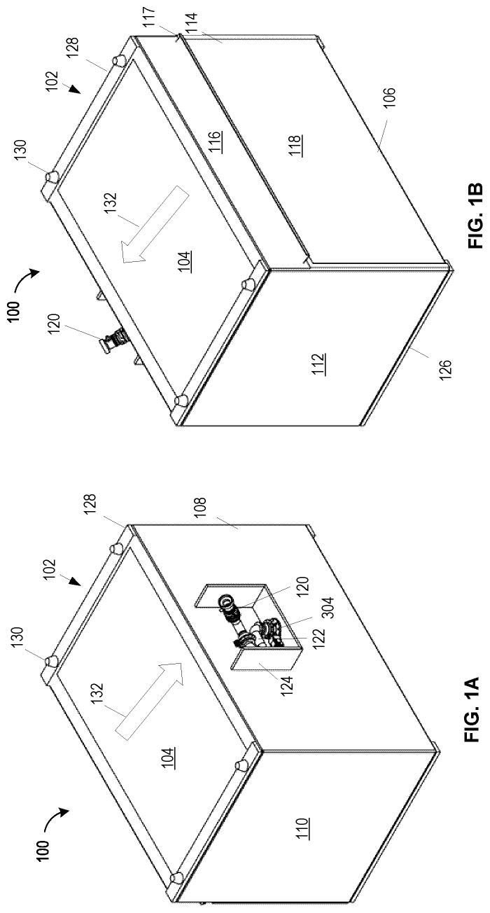

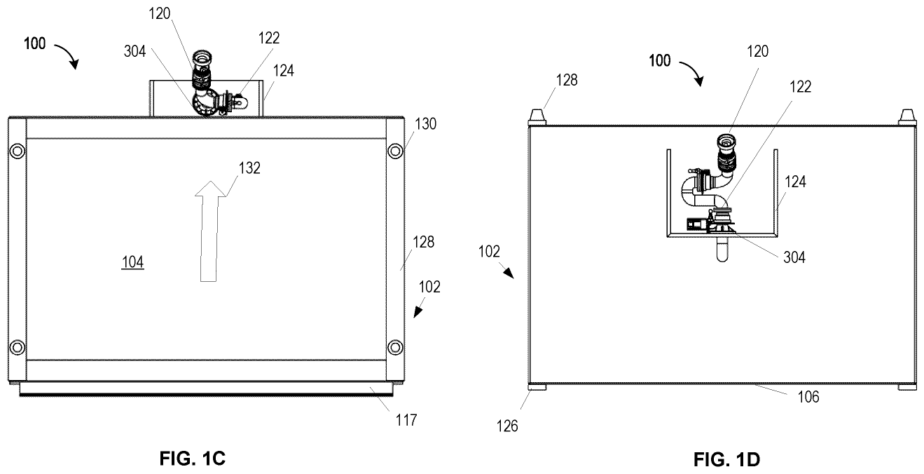

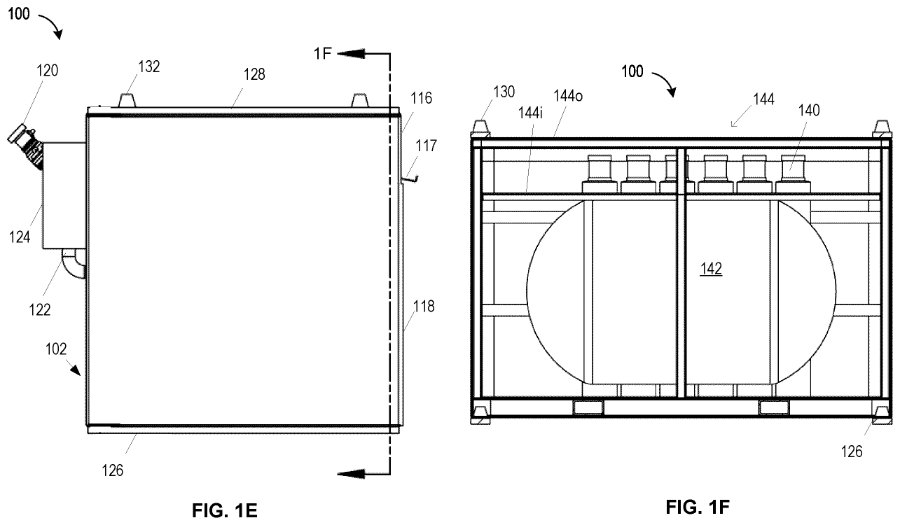

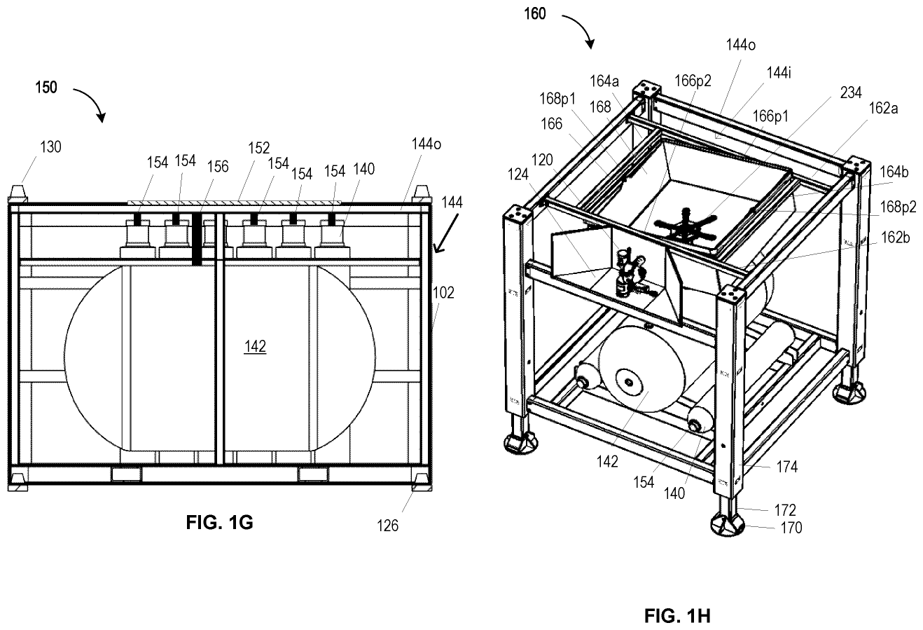

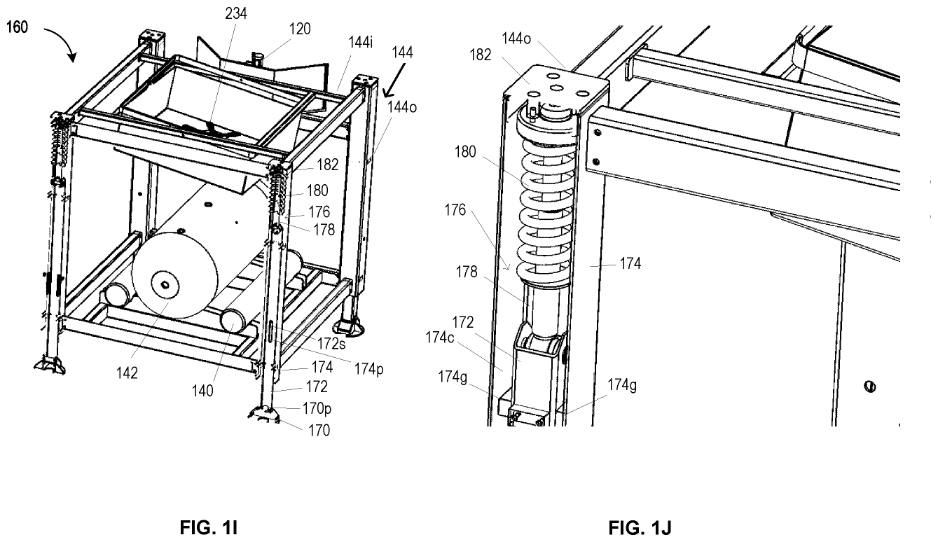

Referring now to FIGS. 1A-1F, shown therein are front perspective, rear perspective, top, front, side and cross-sectional end views, respectively, of an example embodiment of a firefighting device 100 in accordance with the teachings herein. In one aspect, the firefighting device 100 is utilized to fight fires and prevent firefighting injuries or loss of life.

The firefighting device 100 may be portable since it can be transportable by land, air or sea via helicopter, train, truck, trailer, plane, and forklift, or another suitable transportation method, so that it is brought to location where it is deployed and can operate autonomously and/or be remote-controlled. The firefighting device 100 may also be referred to as a semi-portable or mobile firefighting device when it is mounted to a transportation machine such as a flatbed truck, for example, since it can be moved to a deployment position and kept there until it needs to be moved to another location to fight another fire. Alternatively, the firefighting device 100 may be placed moved to a deployed location and then mounted in a permanent position, which may be done for certain locations which always need the presence of a firefighting unit such as, but not limited to, a fuel depot, an oil rig, an airplane hangar, or a person's home or other structure that is located in an area which is prone to the occurrence of fires, such as forest fires for example.

The firefighting device 100 comprises a housing 102 having solid, durable surfaces, one or more tanks (e.g., tank 142) that contain source material for creating a firefighting agent and a propellant system including one canister 140 or several canisters 140 that are connected in series. The one or more canisters 140 and the tank 142 are located in and mounted to the housing 102. The canisters 140 contain compressed gas that aids with deploying the firefighting agent. For example, the firefighting agent may be compressed foam that is created by mixing the source material with the compressed gas and optionally adding water from an optional water tank (not shown) as is known by those skilled in the art. The device 100 also includes a nozzle 120 that is mounted at or recessed from an exterior surface of the housing 102. The propellant system includes pipes and at least one valve that is operatively coupled to the one or more canisters 140, the tank 142, the optional water tank, as well as the nozzle 120. During deployment, the nozzle 120 receives and dispenses the firefighting agent. For example, the propellant system when activated, has one or more controllable valves 418 that are moved to an open position, which results in the firefighting agent being created and propelled through the nozzle 120 to a portion of an operational region of the firefighting unit 100.

The operational region of the firefighting unit 100 may be defined as the entire 3D region that may be covered by the firefighting agent when it is deployed based on the range of angles covered by the movement of the nozzle 120, the strength of the propellant system and the size of the opening of the nozzle 120. The portion of the operational region that is covered by the deployed firefighting agent may have a fire that just started, a fire that is ongoing or it may be an area that a fire is advancing toward. Depending on the aforementioned elements that control the distance of the deployed firefighting agent, the furthest extent of the operational region from the firefighting device 100 may be up to about 120, about 130 or about 140 feet. In at least one alternative embodiment, the nozzle 120 may be mounted so that it is located on the housing 102, partially located in the housing 102 or mostly located in the housing 102 (e.g., see FIG. 1H).

The housing 102 of the firefighting device 100 comprises a rigid fabricated frame 144 (see FIG. 1F) along with several panels that may be removably attached to the frame 144. The frame 144 may be made from a heavy-duty material, such as steel or another suitable heavy-duty material, or from a light-weight material with the required strength such as carbon fiber. In at least one embodiment, the frame 144 includes an outer frame 144o and an inner frame 144i that is coupled to the outer frame 144o (see FIGS. 1H-1I). The dual frame structure can be used in the various embodiments of the firefighting devices described herein that incorporate a drone, for example. The panels generally include a ceiling panel 104 providing an upper surface for the device 100, a bottom panel 106, a front panel 108, side panels 110 and 112 and a rear wall 114 having panels 116 and 118 along with an optional ledge 117 disposed in an upper region thereof. The panel 118 may be removable, or in some cases may not be included to allow for access to components within the firefighting device 100 for certain reasons including maintenance, or to allow a firefighter to take refuge within the firefighting device 100 when it is overcome by fire.

The housing 102 may further include base members 126 along the bottom edges of side panels 110 and 112 to keep the bottom of the housing 102 slightly elevated from the ground. The base members 126 may be strips or beams made of metal or another sturdy material. This may be beneficial in situations where there are fluids on a surface upon which the mobile firefighting device 100 is resting and the elevation provided by the base members 126 prevents the fluids from reaching any cracks in or between the panels 106 to 114 and entering into the firefighting device 100 and causing damage to any internal components. The base members 126 also aid in stability when the firefighting device 100 is stacked on top of another firefighting device as explained further below. In at least one alternative embodiment, instead of base members 126, the housing 102 may include feet or pads that may be coupled to legs an example of which is shown in FIGS. 1H-1I.

In at least one embodiment, the panels 104 to 114 may be made of durable, fire retardant materials. For example, one or more of the panels 104 to 114 may be made using steel plates or another material of suitable durability such as of fire-resistant and strong materials including, but not limited, to carbon fiber and thermoplastic material. In at least one embodiment, the majority or the entirety of the firefighting device 100 may be cladded with fire resistant material. For example, in at least one embodiment, the panels 104 to 114 may have a fire-retardant coating. As another example, one or more of the panels 104 to 114 may be fire rated fire-resistant porous cement or ceramic boards that are available in the marketplace. These boards are typically light weight and strengthened from the inside to provide sufficient rigidity to withstand any impacts during deployment and/or usage. In at least one embodiment, some of the panels 104 to 114 may be made from different materials with respect to the other panels such as, for example, embodiments where one or more of the panels 104 to 114 may be made using steel plates while one or more of the other panels 104 to 114 may be made using the fire-resistant porous cement or ceramic boards.

In at least one embodiment, the firefighting device 100 may also be covered in fire resistant fabric. For example, the fabric may be a super high temperature resistance fabric that can withstand temperatures of more than 1400° F. Examples of such fabrics include, but are not limited to, Industrial 18 oz Vinyl, Sunforger Army Duck, and Duvetyne, for example, or other suitable materials. The fabric may also be very abrasive resistant and waterproof in at least one embodiment.

In general, the frame 144 and panels 104 to 114 of the firefighting device 100 are constructed for increased durability to allow the firefighting device 100 to withstand impact from heavy objects during use. For example, there may be impact to the housing 102 of the firefighting device 100 from a height drop such as when the firefighting device 100 is carried by a helicopter and released near the ground in a region where a fire is to be suppressed and/or extinguished (e.g., put out). As another example, heavy objects may fall on top of or otherwise strike the firefighting device 100 during use. For example, there may be large trees that may fall on the firefighting device 100 due to being weakened from the wildfire. Accordingly, the various panels 104 to 114 of the housing 102 protect the internal components of the firefighting device 100 from physical damage during use. To aid in withstanding these forces during deployment and/or use, at least one of the embodiments of the firefighting device may include a suspension assembly such as shown in FIGS. 1H-1J, for example.

However, in the event that any of the panels 104 to 114 of the firefighting device 100 become damaged or due to wear and tear lose structural integrity and/or its fire retardant coating, they may be removed for repairs and then reattached, or they may be removed and replaced with new panels. Accordingly, the panels 104 to 114 may be removably fastened to the frame of the housing 102 using fasteners such as, but not limited to bolts or latches, for example.

Furthermore, in at least one embodiment, the panels 104 to 114 of the firefighting device 100 may be sprayed with a fire-retardant material so that they have a fire-retardant coating. This may be done from time to time when the firefighting device 100 is serviced for maintenance and repairs. Accordingly, the firefighting device 100 is reusable and can be used in fighting different fires at different locations and different points in time.

In another aspect, in at least one embodiment, in addition to having a heavy-duty frame and strong panels 104 to 114, the firefighting device 100 has an upper frame 128 with posts 130 (only one of which is labeled for simplicity). The posts 130 are sized to be releasably inserted into corresponding channels in the bottom surface of another firefighting device (not shown) thereby allowing multiple firefighting devices to be stacked on top of one another. This may be used when deploying more resources to combat a fire such as when combatting a taller and/or stronger fire. For example, in some situations, two, three or more firefighting devices may be stacked on top of one another during use. In addition, in some use cases, the firefighting devices may be deployed laterally with respect to one another such that they are side by side. Alternatively, in at least one embodiment, the firefighting devices can be deployed on another surface instead of the ground such as on the flatbed of a trailer which allows the firefighting devices to be more mobile, or on a fixed platform.

The nozzle 120 generally sits on a base 304 that is mounted at a portion of the housing 102 using a mount 124 which in this example embodiment is a bracket. In this example embodiment, the nozzle 120 is mounted such that it extends past an exterior wall of the firefighting device 100. However, in alternative embodiments, other mounting techniques may be used and the nozzle 120 may be partially contained within the housing 102, totally contained within the housing 102 or there may be a recessed mount that may be used such that the dispensing end of the nozzle 120 does not extend past the walls of the device, such as the example shown in FIGS. 1H and 1I, Alternatively, in at least one embodiment the housing 102 may have an opening that is large enough to allow the firefighting agent to be unobstructed as it is being deployed from the nozzle 102 and as the dispensing end of the nozzle 120 is being moved in various directions. In an alternative embodiment, when at least a portion of the nozzle 120 extends past the housing 102, the housing 102 may have a small overhang that is located above the nozzle 120 to protect it during use from falling debris. In all of these various embodiments, the nozzle 120 is adapted to receive the firefighting agent through one or more pipes or tubes, one of which is shown as pipe 122. In at least one embodiment, the nozzle 120 and/or the pipes/tubing can be sprayed with a fire-retardant coating or covered by a fire-retardant fabric.

Referring now to FIGS. 1H to 1J, shown therein is another example embodiment of a firefighting device 160 that incorporates a drone 234 and a suspension assembly 170. These elements may be added to the other embodiments of the firefighting devices described herein. For firefighting devices that contain the drone 234, an inner frame 144i, which is coupled to the outer frame, may be used for mounting a pivoted cage or pivoted basket 168 for housing the drone 234. The basket 168 may be considered as a mount that provides a surface for housing the drone 234 such that the drone is horizontally level after deployment of the device. For example, the inner frame 144i may include a bracket that has a pair of crossbars 162a and 162b that are generally parallel and spaced apart and connected to the outer frame 144o and another pair of crossbars 164a and 164b that are generally parallel and spaced apart and perpendicularly mounted to the crossbars 162a and 162b. A second inner frame 166, which may have the same general shape as the inner frame 144i and fits within the inner frame 144i, is pivotally connected to the inner frame 144i via the pair of crossbars 162a and 162b at pivot points 166p1 and 166p2 to provide a first pivot axis about a first horizontal axis. The basket 168 has a bottom wall and four side walls with an upper opening defined by upper portions of the four side walls. The basket is pivotally connected to the second inner frame 166. Accordingly, the basket 168 has the same general shape as the second inner frame 166 but is sized to fit within the second inner frame 166 such that the upper portions of two sidewalls of the basket 168 that are generally parallel with the second pair of crossbars 164a and 164b are pivotally coupled to corresponding portions of the second inner frame 166 at pivot points 168p1 and 168p2 to provide a second pivot axis about a second horizontal axis that is generally orthogonal to the first pivot axis. The basket 168 thereby acts as a two axis gimbal which allows for the bottom of the basket 168 to be horizontal so that the drone 234 can take off from and land onto a horizontal surface regardless of whether the firefighting device 160 is deployed such that it is horizontally level or is sitting on a surface that is not level and therefore is tilted.

Referring to FIGS. 1H and 1I, the firefighting device 160 includes four feet with only foot 170 being numbered for simplicity of illustration. The foot 170, which may also be called a pad or a base, may be pivotally coupled to the leg post 172 at pivot point 170p so that the bottom of the foot 170 may be flat or angled to match the topology of the surface upon which the firefighting device is 160 has been employed while the main housing of the firefighting device is generally vertical. Alternatively, the top of the foot 170 may have a ball or be ball-shaped while the bottom of the leg post 172 may have a socket within which the ball portion of the foot may be contained such that the foot can rotate about the socket. The left and feet elements of the firefighting device 160 may be incorporated into any other embodiments of the firefighting device 160 described herein.

Referring now to FIGS. 1H-1J, the outer frame 144o includes four leg frames 174, only one of which is labelled for simplicity, with 4 side walls defining a channel therebetween. The leg posts 172 are slidably received within the channels of the leg frames 174. The upper portion of the leg posts 172 are coupled to the lower ends of pistons 178 that are part of shock absorbers or isolation dampers 176. The upper ends of the pistons 178 have a spring 180 and are coupled to a portion of the outer frame 144o such as the upper corners 182. Together, the slidable leg posts 172 and the shock absorbers 176 provide a suspension assembly for the firefighting device 160. In at least one embodiment, the leg post 172 may include a groove or slot 172s with which a post 174p that is integral with or attached to the leg frame 174 may slide as the suspension assembly is engaged. The upper and lower ends of the slot 172s limit a linear range of motion for the leg post 172 within the leg frame 174. In at least one embodiment, the interior of the leg frame 174 may include guide members 174g, which may be rectangular inserts, that may be used to guide the sliding movement of the leg posts 172 within the leg frame 174. The suspension assembly, optionally the slot 172s and post 174p, and optionally the guide members 174g may be used in other embodiments of the firefighting devices described herein. In other embodiments, the location of the shock absorbers 176 may vary. Accordingly, the suspension assembly is coupled with the outer frame to provide shock absorption when the device is deployed or when the device experiences an impact during use.

The outer frame 144o can also provide a housing for the electronics, batteries and other hardware components to protect such components from forces encountered during deployment and use. The suspension assembly acts to provide the firefighting devices that utilize it with an isolation (dampening) structure that allows the internal components of the firefighting device to be able to withstand multiple “G's” of lateral and compressive forces (e.g., shock loads) during deployment and use. The suspension assembly may be implemented such that they absorb all or most of the loads from the x, y and z directions. For example, the suspension assembly may be designed to absorb forces from about a 4 foot Heli-drop. Accordingly, the firefighter devices that use a suspension assembly may be able to protect the sensitive electronics and other interior components described herein from damage during deployment and/or use. In alternative embodiments, other shock absorption elements may be used to implement the suspension assembly.

Referring now to FIGS. 1F-1I, the source material for the firefighting agent is contained within the tank 142 while the compressed gas is housed within the canisters 140. Both the tank 142 and canisters 140 are generally secured to the frame 144 of the housing 102. The tank 142 is preferably secured to the housing 102 in a horizontal fashion while the canisters 140 may be housed in a vertical fashion (e.g., see FIGS. 1F and 1G) or in a horizontal fashion (e.g., see FIG. 1H-1I). The horizontal orientation of the canisters 140 and tank 142 is preferred as this provides for a low center of gravity for the firefighting devices described herein which aids during aerial deployment such that the firefighting device is oriented properly, e.g., in a standing or vertical position. In alternative embodiments, there may be more than one tank 142. Either orientation of the canisters 140 and the tank 142 shown in FIGS. 1F-1I may be used in the other embodiments of the firefighting device described herein, although the horizontal orientation is preferred.

In at least one embodiment, the propellant system may use compressed air or other compressed gas, during deployment of the firefighting agent, to aid in propelling the firefighting agent from the nozzle 120. Since the canisters 140, tank 142 and other components of the propellant system are located within the housing 102 they are safe from the fires that are exterior to the housing 102 and being fought by the firefighting device.

As previously mentioned, physical deployment of the firefighting devices described herein can be by helicopter, off road trucking, cranes or other material handling devices. The material used for the panels 106 to 114, inner frame 144i and outer frame 144o as well as the number and size of the canisters 140 and tank 142 can be selected to optimize the weight to payload ratio of the firefighting device. For example, the lighter the housing 102 and the other structural components of the firefighting device, the more the amount of the materials for generating and propelling the firefighting agent that can be contained so that the firefighting devices described herein can operate longer when fighting a fire. Accordingly, through the design process of the firefighting devices described herein the amount of the firefighting agent may be maximized by designing the various components of the firefighting devices to have certain masses.

The combination of the propellant (e.g., compressed/pressurized gas such as carbon dioxide or air) from the canisters 140, source material for the firefighting agent from the tank 142 and optionally water from an optional water tank (not shown) is such that the firefighting agent is deployed at a relatively constant pressure. For example, the amount of compressed air may be selected to be proportional with the amount of firefighting agent to be deployed. For example, if it takes one33 2,000 psi compressed CO₂ tank to fully propel 1 gallon of firefighting agent (e.g., foam) a distance of 180 feet, it takes six 2,000 psi CO₂ tanks to propel 6 gallons of propellant the same distance. The amount of pressure and the size of the piping is used to achieve a known flowrate and a maximum distance that the firefighting agent can be projected towards the region having the fire. The compressed gas pressure may also be selected according to the regulations specified by certified standards (e.g., CSA, TSSA, UL, etc.).

Referring now to FIG. 1G, shown therein a cross-sectional view of another example embodiment of a firefighting device 150 in accordance with the teachings herein. In this example embodiment, the firefighting device 150 includes a cover 152 in the housing 102 which may be opened to provide access to quick connect couplings 154 to the canisters 140 that contain the compressed gas and a quick connect coupling 156 for the tank 142 that contains the source material for creating the firefighting agent. There may also be a water tank and other physical components that are not shown but used in the creation and propelling of the firefighting agent as is known by those skilled in the art. These quick connect couplings allow for the canisters 140 and the tank 142 to be connected to corresponding tanks of a fill station, or other source, which may be at a fixed location or may be mobile (e.g., provided by a truck), such that when the firefighting agent and/or propellant are depleted, they can be replenished. Similar connections are available for an onboard water tank (not shown). The cover 152 and quick connect couplings 154 may be located in another region of the firefighting device so that it does not interfere with the housing and the bay doors used if the firefighting device employs a drone as described herein.

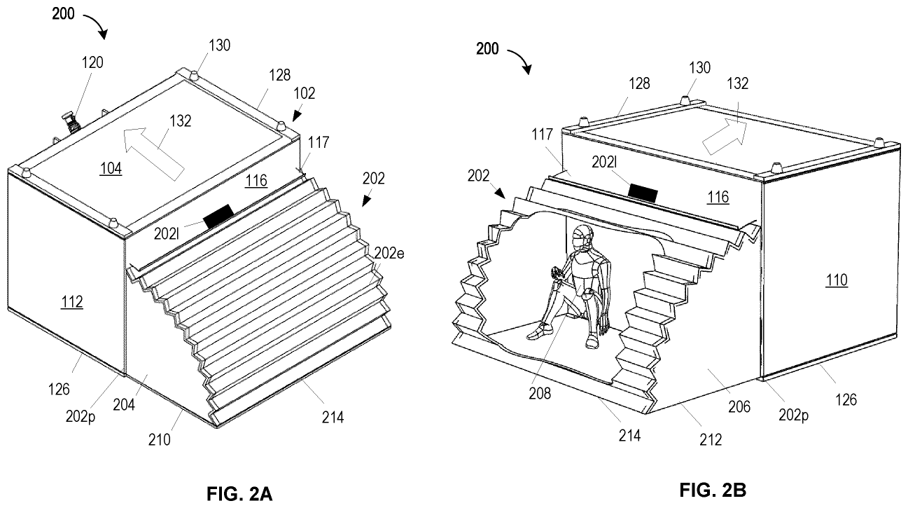

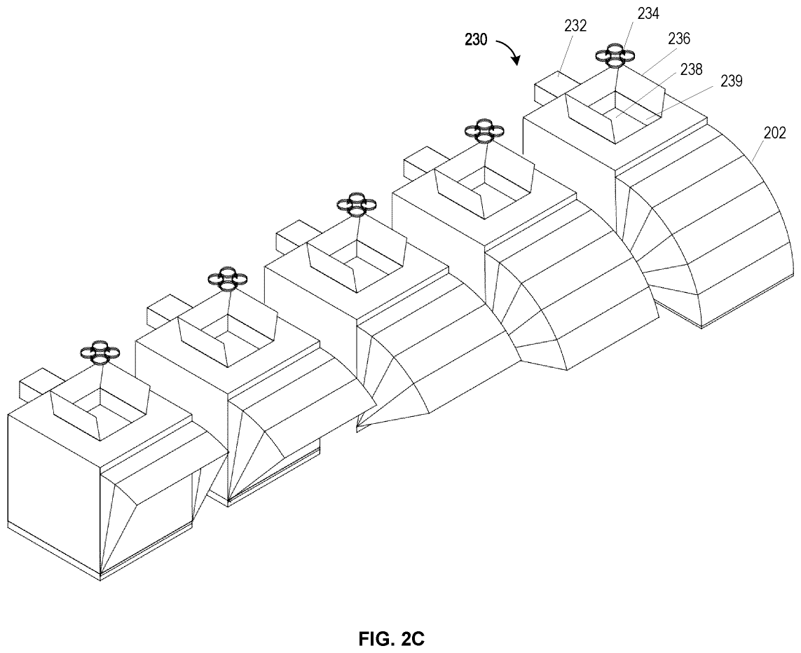

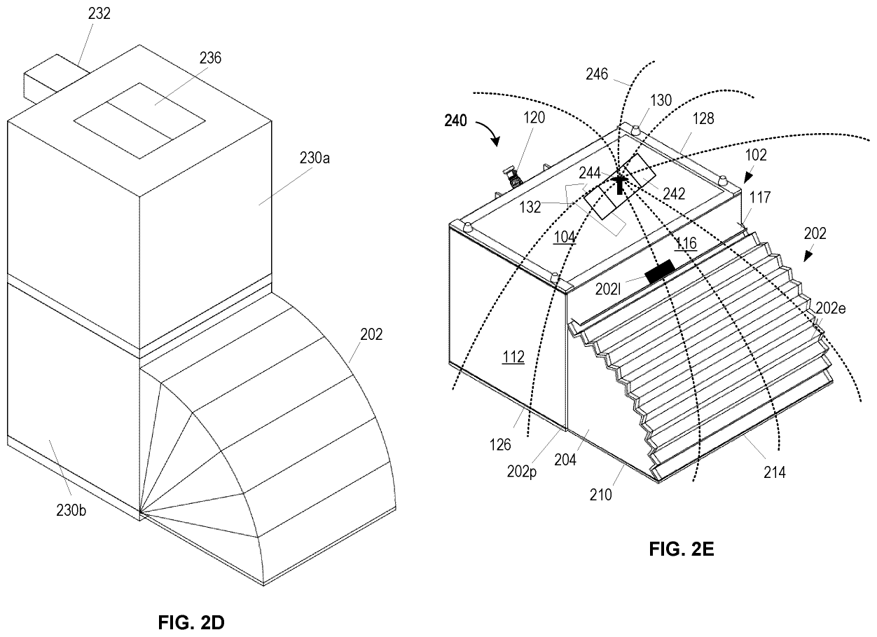

Referring now to FIGS. 2A-2B, shown therein are a right rear perspective view and a left rear perspective view with a partial cutout, respectively, of another example embodiment of a firefighting device 200 in accordance with the teachings herein. The firefighting device 200 is similar to the firefighting devices 100, 130, 150, 160 but also has a retractable cover 202 that can be deployed from the rear of the firefighting device 200 to provide protection for firefighters and allow for quick rescue when fire suddenly overtakes the firefighting device 200. The elements related to the retractable cover 202 may be used with other firefighting devices described herein.

The retractable cover 202, which may also be referred to as a canopy, is made using a retractable bellow-type material 202e or pleated material 202e that is fire retardant or may be sprayed with a fire-retardant coating. For example, the retractable cover 202 may be made using fire retardant material such as a super high temperature resistance fabric that can withstand temperatures more than 1400° F. In at least one embodiment, this fire-retardant fabric can also be used to cover the housing 102 of the firefighting device 200. The pleated material 202e allows for expansion of the cover 202 as it is deployed. The cover 202 may be mounted to the housing 102 and is extendable from a closed position to an open position in which the cover 202 is extended to the ground and is adjacent to an upper rear portion and also the side portions of the housing of the firefighting device 200 to provide an enclosure for at least one person for protection from fire that partially or fully engulfs the firefighting device 200. This provides a more effective way of protecting a firefighter compared the conventional method of having firefighters dig down into cool earth and then wrap themselves up in a reflective blanket if they will be soon overtaken by an oncoming fire.

For example, referring to FIGS. 2A and 2B, the retractable cover 202 has sides 204 and 206 and is extendable to reach down to the ground to provide an enclosure that is sealed as much as possible from the external environment to provide a safe zone for one or more firefighters 208 that need to take refuge from an oncoming fire that is about to overtake them. An example of the various stages of deployment for the retractable cover 202 is shown in FIG. 2C for firefighting device 230 which is an example of another alternative embodiment (the firefighter is not shown in FIG. 2C for ease of illustration). The enclosure is provided by using materials for the cover that hold their shape when deployed so that the material does not touch the firefighter when they are taking refuge in the enclosure.

Although the firefighting devices are shown herein with a frame having a square or rectangular shape, it should be understood that other shapes can be used for the frame in other embodiments. These other shapes may be used for the frame of the firefighting devices to facilitate different types of deployment. For example, in some embodiments, the shape of the frame may be a triangle or an octagon.

In at least one embodiment, the rear of the firefighting device 100, 150, 200 or any alternative herein may also provide access to a supply of drinking fluids, communication equipment and/or an oxygen supply for the firefighters 208 who may or may not be in the covered surrounding provided by the retractable cover 202. The drinking fluids or oxygen supply may be in cabinets or drawers at (e.g., within) the rear of the mobile firefighting device 100, 150 or 200 or any alternative herein.

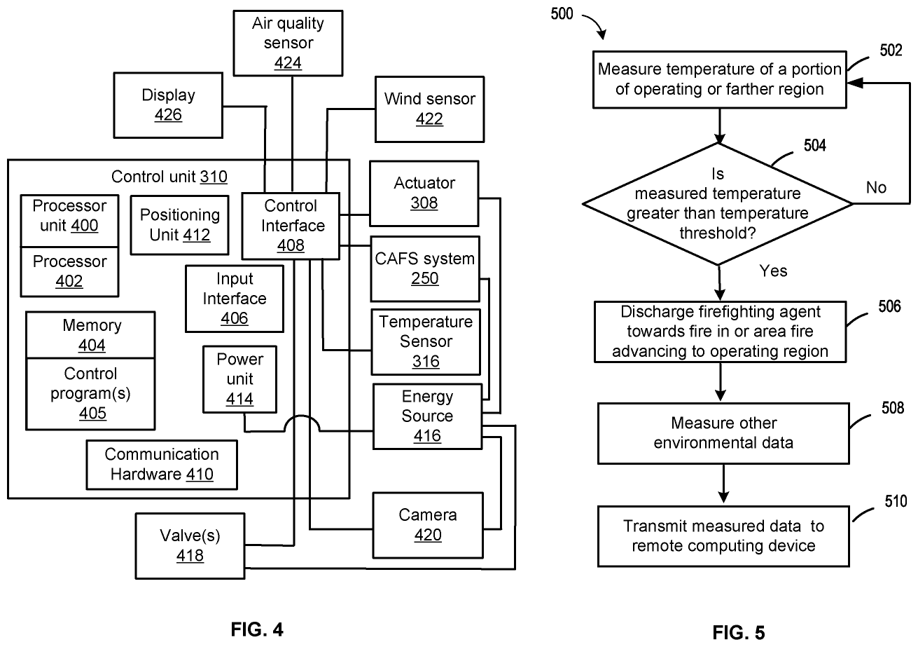

In at least one embodiment, the rear of the firefighting device 100, 150, 160, 200 or any alternative herein may also provide access to a communication device that is included in the housing of the firefighting device 100, 150 or 200 (see FIG. 4 for example).

Referring to FIG. 2B, in at least one embodiment, the firefighting device 200 may comprise a sidewise C-shaped frame with sidebars 210 and 212 having end portions that are pivotally connected to the bottom side corners 202p of the housing 102 and a crossbar 214 that is attached to the upper ends of the sidebars 212. The sides 204 and 206 and end portion of the expandable cover 202 are attached to the C-shaped frame. The firefighting device 200 also has a latch 2021 or fire-resistant strap that is used to releasably hold the cross bar 214 along the bottom edge of the ledge 117. When the expandable cover 202 is to be deployed the latch 2021 or strap is released. In an alternative embodiment, a mechanical deployment mechanism may be used in which gears and a motor are operatively coupled to the C-shaped frame to extend and retract the cover 202.

In at least one embodiment, such as in the embodiments shown for the firefighting devices 100, 150 and 200 or alternatives thereof, these devices may also include an indicator 132 that is located on an upper surface of the housing 102 to indicate a forward direction of the devices 100, 150 and 200 where the nozzle mount 124 is located (i.e., the nozzle 120 is mounted). This allows one to determine from an aerial view the direction that the nozzle 120 of a given firefighting device described herein is pointing which can help with deployment of the device. For example, during aerial deployment, a pilot may view the indicator 132 and use it to make sure that the firefighting devices described herein are placed on the ground, or other surface, so that the indicator 132 points in the direction of a portion of a fire that is to be suppressed.

In at least one embodiment, any of the firefighting devices described herein may include one or more actuators for pivoting the direction of the “firing end” of the nozzle 120 from which the firefighting agent 246 is deployed. For example, the actuator(s) may be used to move the nozzle 120 up or down and/or from side to side and may be fully automated in at least one embodiment (the nozzle may be referred to as a “monitor”). This is described in further detail below.

Referring now to FIG. 2C, shown therein are a series of images showing a firefighting device 230 with the retractable cover 202 being deployed. Only one of the images is numbered for ease of illustration. The firefighting device 230 includes a nozzle cover 232 to cover the top portion of the nozzle (not shown) to protect it from impact during deployment or use. The nozzle cover 232 may be used for the other firefighting devices described herein.

The firefighting device 230 also includes a drone 234 that may be used for surveillance purposes. This drone 234 may be used with other firefighting device embodiments described herein. In order to deploy or land the drone 234 from the firefighting device 230, flaps or doors 236 open to provide an opening 238 through which the drone 234 can move during vertical takeoff and vertical landing. A top portion of the frame has a mount 239 to support the drone 234 securely when the drone 234 is not being used. The mount 239 may be provided by the basket 168 as described in FIGS. 1H-1I. The flaps or doors 236 may be pivotally connected to roof/ceiling panel of the firefighting device 230 such as by using hinges. Alternatively, the doors 236 may or may be mounted such that they slidably engage the firefighting device 230 and may be slid open or closed (this may be done using roller wheels and a track for example). In either case, actuators may be connected to the doors 230 and the actuators may be remotely or autonomously operated in order to open and close the doors 230 before and after take-off or before and after landing. For example, a pressure switch, or other switch or latch, may be used to automatically control the doors 230 to open and close. These switches may be operated autonomously under control of a processor at the firefighting device in response to analysis of certain sensor measurements (i.e., temperature readings or air quality measurements), via preprogrammed software commands or via remote control signals.

For example, in at least one embodiment, the operation of the doors 236 may be operated under the control of a processor of the firefighting device 230 which executes software instructions that allows one to pre-program the processor to open the doors 236 and launch the drone when certain events occur such as at a predetermined time after the device 230 is deployed. Alternatively, the drone deployment may be programmed such that it occurs according to various deployment scenarios while the firefighting device 230 is operational, such as hourly, daily, weekly, or monthly, for example.

The flaps or doors 236 can be made using the same material as the panels 104-118. The drone 234 is released at “point-of-use”, as opposed to consuming valuable battery time in traveling to the location. The drone 234 has at least one camera, such as a color camera, a white light camera (for obtaining images at night, dusk or under poor lighting conditions) and/or an infrared camera for obtaining thermal images, and at least one sensor so that it may be used for overhead surveillance (i.e., situational awareness) and telemetry to measure, record and/or communicate environmental conditions (such as temperature, pressure and/or air quality) with a command center, other firefighting devices and/or firefighters. In at least one embodiment, the drone 234 may record a video showing the entire firefighting technique employed by the firefighting device 230 which may be used to assess its performance. In at least one embodiment, the images obtained by the drone 234 may be used to adjust the deployment of the firefighting agent as will be described later. The drone 234 also have a mapping feature that can be used to map the operational region and regions outside of the operational region to determine the location and/or advancement of the fire front. For example, the mapping feature can be used to determine a position of the firefighting device, a predetermined distance threshold from the firefighting device that acts as a threshold when operating the firefighting device in a proactive manner (described below) and image analysis including edge detection can be used to determine the fire front and its location relative to the firefighting device and/or the predetermined distance threshold which can be compared to the predetermined distance threshold or another condition to determine when to send an activation signal to the firefighting device to autonomously deploy the firefighting agent. This signal may also include direction coordinates so that the nozzle can be moved to face the proper direction for deploying the firefighting agent.

In some embodiments, the drone 234 may be tethered to the firefighting device 230, which provides various benefits. For example, the use of tethered drones avoids regulatory issues relating to needing a pilot to operate the drone, and/or having the drone operate beyond visual line of sight. Other benefits include being able to provide power to the drone if there is a power wire that is in the tether, providing the ability to guide and reel the drone back into the firefighting device during severe weather and avoiding data transmission interruptions if data is transmitted a communication line that is in the tether instead of wirelessly transmitting the data. Tethered drones may also be operated more safely in sensitive areas such as airports, for example.

Referring now to FIG. 2D, shown therein is an example usage of the firefighting devices described herein. In this example, two of the firefighting devices 230 are shown where firefighting device 230a is stacked on top of firefighting device 230b. This can be useful when more than one firefighting device is needed to combat a fire and the fire is tall. The cover 202 of the lower firefighting device 230b may be deployed to protect any firefighters that are in the vicinity of the firefighting device 230b and need to take shelter from the incoming fire.

Referring now to FIG. 2E, shown therein is a left rear perspective view of another example embodiment of a firefighting device 240 in accordance with the teachings herein. The firefighting device 240 contains flaps or doors 242 which can be opened and closed and an additional nozzle 244. The additional nozzle 244 which has a storage position within the housing of the of the firefighting device 240, similar to the mount of the drone 234, and an operational position in which the doors 242 are opened and the additional nozzle 244 is extended upwardly so that firefighting agent 246 can be deployed from the additional nozzle 244. For example, this action can happen when the retractable cover 202 is deployed so that the firefighting agent 246 can be used to protect the firefighting device 240 as well as the people that are taking refuge underneath the deployed cover 202 when the firefighting is about to be or has been overcome by fire.

To aid in the deployment of the additional nozzle 244, the firefighting device 240 has a sensor for sensing when the retractable cover 202 is deployed. For example, a contact switch may be used, and this contact is broken once the cover 202 begins to be opened. The firefighting device 240 may have an additional actuator, such as a servo motor, that is used to raise and lower the auxiliary nozzle 244 thereby moving the additional nozzle 244 between the storage and operational positions. In other embodiments, the additional nozzle 244 may be mounted in a recessed position so that it does not have to be raised and lowered and may just be operated to deploy the firefighting agent when the cover 202 and the doors 242 are opened. In at least one embodiment, there may not be doors 242 and the additional nozzle may be mounted on an upper surface of the firefighting device and in some cases this surface may be recessed relative to the rest of the upper surface of the firefighting device. In addition, the additional nozzle 244 is coupled by a pipe or tube to the various tanks via an auxiliary valve, such as a solenoid valve, to receive the firefighting agent 246. The additional nozzle 244 may be pressurized to aid in deployment of the firefighting agent 246. The firefighting agent 246 can be deployed according to any pattern that may be predetermined and stored in the memory of the firefighting device. An example of such a pattern is an umbrella type pattern as shown in FIG. 2E. These actions may be automated or may be under the control of a main processing unit, which is described in further detail below.

It should be noted that with the various embodiments of the firefighting devices described herein that have a cover, the cover can be deployed in situations where the main nozzle 120 is operating or not operating but the additional nozzle 244 will be operating due to deployment of the cover 202 and opening of the doors 242. The additional nozzle 244 and other elements needed for operation may be incorporated into other embodiments of the firefighting devices described herein.

It should be noted that in the various embodiments of the firefighting devices shown herein there may be other alternative embodiments in which there is more than one nozzle that is used to deploy the firefighting agent in a different configuration than that which was described and shown for firefighting device 240. For example, additional nozzles may be mounted or located at different faces of the firefighting device and connected to the CFS 250 (i.e., the propellant system including the canisters of compressed gas, the one or more tanks of source material for the firefighting agent and optionally water) via a multi-port valve and piping such that the multi-port valve can be controlled to provide the firefighting agent to one or more of the nozzles on the different faces in order to suppress fires that face more than one wall/side of the firefighting devices (as indicated by the indicator 132). For example, in addition to the forward facing nozzle 120, a first lateral nozzle may be mounted/located at a first side panel, a second lateral nozzle may be mounted/located at a second side panel, a rear nozzle may be mounted/located at a rear panel or any combination of these nozzles may be incorporated onto the firefighting device. Accordingly, a firefighting device with multiple nozzles can handle more complicated scenarios, such as fire coming from more than one direction.

Also, firefighting devices with multiple nozzles at different walls facing different directions may not be as sensitive to placement sensitive since it can deploy the firefighting agent towards multiple directions. For example, in at least one embodiment, a firefighting device with nozzles mounted at different walls so that they can deploy the firefighting agent in different directions may be controlled by an onboard processor in an automated manner where the processor determines from which direction a fire is moving towards the firefighting device based on data received from sensors associated with the different nozzles, or receives this data from another device such as a remote command center, and then autonomously deploys the firefighting agent from the nozzle that is facing the oncoming fire. In an alternative embodiment, the drone 234 may use its mapping feature to determine the direction that the fire front is moving and provide a control signal to the firefighting device for selecting one of the nozzles for deploying the firefighting agent towards the fire front.

In an alternative embodiment, another action that may occur when the cover 202 is deployed is that an alert signal may be generated and transmitted to a remote device, such as a computer at a central station, or the alert signal may be output as an audible or visual alarm, to provide an alert that the cover 202 has been deployed. In addition, in at least one embodiment, a GPS signal may also get transmitted to indicate the location of the firefighting device 240.

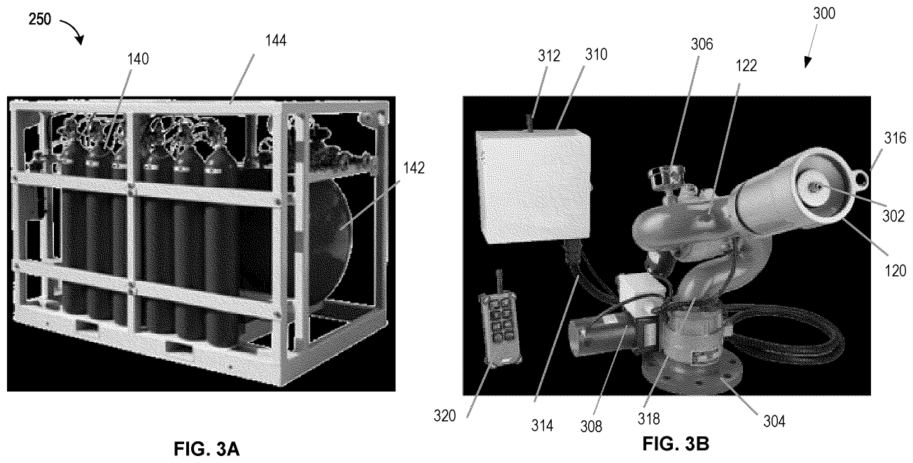

Referring now to FIG. 3A, shown therein is a perspective view of an example embodiment of a compressed foam system (CFS) 250 that may be used by one of the firefighting devices described in accordance with the teachings herein, such as the firefighting device 100, 150, 160, 200, 230, 240 or alternatives thereof. The CFS 250 includes the tank 142 holding source material for the firefighting agent, canisters 140 containing compressed gas (e.g., air or nitrogen but preferably an inert gas) that aids in deploying compressed air foam as the firefighting agent and an optional water tank for providing water that may optionally be added during creation of the firefighting agent. A portion of the frame 144 is used for securing these elements in place. The weight of the CFS 250 is selected so that the amount of the firefighting agent that is created is maximized and the total weight of the firefighting device 100, 150, 160, 200, 230, 240 or an alternate embodiment thereof is not more than the acceptable load of the transportation mechanism that is used for transportation and deployment, such as the total load of a typical helicopter used for lifting and transport purposes.

In at least one embodiment, the foam that is used as the firefighting agent may be a mix of a source material (which may be in a powder or concentrate form), compressed gas and in many cases also water. When these three components are mixed it results in the firefighting agent.

In at least one embodiment, the compressed gas that is used may be inert so that it is non-combustible and/or non-flammable. For example, the gas may be argon, helium, nitrogen, neon or a combination thereof.

There are many examples of different input ingredients that may be used to create the final firefighting agent, and they may be selected based on the type of fires that will be fought by the firefighting devices described herein.

For example, fires can be classified differently based on the type of material that is burning such as class A, B, C and D fires. Class A fires are solid material fires that are due to conventional combustibles such as wood, paper and plastic, for example. Class B fires are due to flammable liquids or gases such as fuels, alcohol, and aerosols, for example. Class C fires are electrical fires. Class D fires are due to combustible metals such as magnesium and potassium, for example.

Since there are different classifications for fires, there are different categories of firefighting agents including primary agents, supplementary agents and other agents, which may be selected from for fighting different class of fires. Primary Agents include foam fire suppressants that may have a combination of bubbles with lower specific gravity than hydrocarbon fuels or water, and the foam may have strong cohesive qualities, high water retention, can flow freely over a burning liquid surface, is dense, is stable to intense thermal radiation, and/or can provide re-sealing activity. Supplementary agents are formulated for addressing unique fire fighting requirements, and may be used on their own or with foam for certain fire fighting operations such as combatting fuel fires. Some examples of supplementary agents include Dry Chemical, Halotron®, or Carbon Dioxide, for example. The third category of “Other Agents” include other special-use fire extinguishing agents such as for fighting Class D fires. Other agents may include “wetting agents” for fighting certain fires and may be either in liquid or powder form.

In at least one embodiment, the CFS 250 may have a mixing chamber where the source material components to create the foam that is used as the firefighting agent. For example, a water pumping system may be used that that has an inlet where compressed air can be added to a foam solution to generate foam as the firefighting agent. An air compressor can also be used in some embodiments to propel compressed air foam farther compared to aspirated or standard water nozzles. As another example, an embodiment may include a water source, a centrifugal pump, foam concentrate tanks, a direct-injection foam proportioning system on a discharge side of the pump, a mixing chamber or mixing device, a rotary air compressor, and control systems that control the amounts of concentrate, water, and gas that are mixed.

In at least one embodiment, the CFS 250 may be designed to create a certain amount of firefighting agent and the components of the CFS 250 may weigh from about 5,000 to about 15,000 lbs when loaded. However, the size of the components of the CFS 250 may be selected based on the total size and weight specifications of the firefighting device 100, 150, 200, 230, 240 or an alternate thereof which may be dictated by the load restrictions of a transportation vehicle used to transport the firefighting device. For example, the weight of the firefighting device with the materials and gas needed to generate and deploy the firefighting agent may range from about 5,000 to 9,000 pounds when the mode of transport is a helicopter, which may be a typical firefighting helicopter. Alternatively, this weight of the firefighting device may range from about 9,000 to 15,000 pounds when the mode of transportation is ground transport.

Advantageously, the CFS 250 does not include any on-board combustible fuels or any fossil fuels and is therefore safer to operate and is emissions friendly. Furthermore, the spray foam is about 15-30 times more effective than water alone. In addition, when using water as the firefighting agent water will evaporate with the heat whereas foam creates a fireproof film around the combustible materials inhibiting the spread of fire. The delivery system that may be used may be for Class A & B foam for the mitigation of structural and hydrocarbon fire hazards. When the compressed gas that is used to discharge and aspirate the foam does so at a minimum of a 10:1 expansion ratio, the firefighting capabilities may be about 15-30 times more effective from a weight to effect ratio compared to when water alone is used, and a similar fire maybe extinguished using a volume of spray foam that is less than 5 times the volume of what that is needed. Accordingly, firefighting devices that use spray foam do not weigh as much and can be more easily transported by helicopter.

However, in at least one embodiment, water may be used as the firefighting agent in the firefighting device 100, 150, 200, 230 or 240 or an alternate thereof instead of spray foam where it is advantageous in certain situations. This may be when these firefighting devices can be connected to a large water supply and/or when these firefighting devices are not moved as often to different deployment locations. In such embodiments, the propellant system may comprise an air pump for discharging water from these firefighting devices when water is used as the firefighting agent.

Alternatively, in at least one embodiment, in addition to having the on-board CFS 250, the firefighting devices described herein may have other components, such as the quick connect valves described earlier, so that the firefighting devices can be connected to an external water and/or foam source that may be used as the firefighting agent. In another alternative embodiment, one or more lines can be directly connected to the firefighting devices to allow for continuous use of water from a water source, continuous use of firefighting agent from a firefighting agent source and/or continuous use of inert gas from an inert gas source.

Referring now to FIG. 3B, shown therein is a perspective view of an example embodiment of a nozzle assembly 300 as well as fluid transport components, electronic and communication components that may be used by the firefighting devices described herein or alternatives thereof in accordance with the teachings herein.

The spray nozzle assembly 300 includes the nozzle 120 having a nozzle tip with an opening 302 (which may be adjustable), a pipe 122 that is in fluid communication with the nozzle tip 302, and a moveable mount 304 that is attachable to a portion of the firefighting device 100, 150, 160, 200, 230, 240 or alternatives thereof and is also attachable to the pipe 122. The spray nozzle assembly 300 also includes a controllable valve (not shown) that can be autonomously controlled to deploy the firefighting agent.

In at least one embodiment, the spray nozzle assembly 300 may further include an actuator 308 for moving the moveable mount 304 so that the direction of the nozzle tip 302 can be moved in a desired fashion to direct the deployed firefighting agent in a desired direction (e.g., follow a desired pattern), as is described further below. The moveable mount 304 may be implemented to allow for two degrees of freedom or more for movement of the nozzle tip 302.

The nozzles that are used in the various firefighting devices described herein may also be known as monitors which have the ability to articulate in a multitude of directions and compound angles. For example, one motor may be used to control/rotate a first arm that is coupled to the base of the nozzle in a side to side motion and another motor can be used to control/articulate a second arm that the nozzle is attached to in an upwards and downwards motion. These motors may be servo driven to allow pre-determined fire fighting nozzle movements to be used during firefighting by using software instructions to control the operation of the motors. However, the onboard processor of the firefighting device may autonomously select one of several stored predetermined patterns using techniques described herein.

The firefighting devices 100, 150, 160, 200, 230, 240 or alternatives thereof also include a control unit 310 with communication equipment including an antenna 312 for sending signals including operational data and/or environmental data to a remote computing device. The control unit 310 also includes a power supply unit (e.g., power supply unit 414 in FIG. 4) for providing power to the actuator 308 via a power cable 314. The control unit 310 is also in communication with valve for providing control signals thereto during operation.

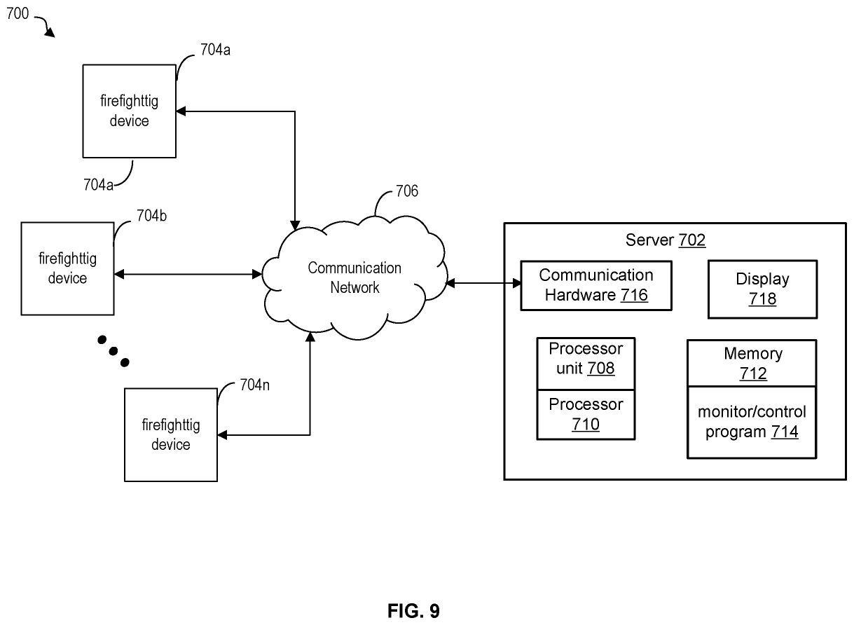

The remote computing device may be a smart phone, a laptop, a desktop, a tablet or a server (e.g., server 702 in FIG. 9). The remote computing device may be at a central command center. The remote computing device may be used to monitor the operational status of the firefighting devices described herein as well as various conditions (e.g., measured temperature, wind and/or air quality data) of the nearby environment, i.e., proximal region, of the firefighting devices described herein, where a fire may be located. The monitoring may be done to make decisions in terms of whether any repairs need to be made to any of the firefighting devices described herein, or any additional firefighting agent or compressed gas is to be provided to any of the firefighting devices described herein before, during or after operation. The operational and environmental data received by the remote computing device may also be used to determine whether any additional firefighting assets, including other firefighting devices, may have to be deployed to assist in fighting and extinguishing any fires.

The firefighting devices described herein can also include a temperature sensor 316 that is communicatively coupled to the control unit 310 via a cable 318. The temperature sensor 316 is mounted to the side of the nozzle 120. The temperature sensor 316 measures the temperature of the region that is proximal to the firefighting devices described herein and sends the temperature measurement data to the control unit 310 for further processing as is described in further detail below. The temperature sensor 316 may be an infrared sensor such as an infrared camera in some cases.

The firefighting devices 100, 150, 160, 200, 230, 240 or any alternatives thereof can also include a camera 420 (see FIG. 4) to provide images of the operational region of the firefighting devices and optionally regions adjacent to and outside of the operational region depending on the range of the camera 420. The camera 420 may be a thermal camera to obtain thermal images of one or more portions of the operational region which may then be analyzed by a processor of the control unit 310 or the remote computing device for determining the hottest areas of a fire that is shown in the captured images. A thermal camera is not affected by smoke and heat and so it can be used to determine the hottest spot of a fire to direct the firefighting agent at. The camera 420 can be mounted to the side of the nozzle 120 for providing the image data directly along the line of sight of the nozzle 120.

Alternatively, the camera 420 may be a color camera, a black and white camera or a white light camera to provide color, black and white or illuminated images, respectively, of the operational region. The images taken by the camera 420 may be sent by the telemetry of the control unit 310 to any remote computing devices that are used to monitor environmental conditions of the operational region and regions adjacent thereto, and/or the operation of any of the firefighting devices described herein. Accordingly, the images obtained by the camera 420 can be used to monitor any changes in the direction of an incoming fire over time.

Referring now to FIG. 4, shown therein is a block diagram of an example embodiment of the control unit 310 and various hardware elements that may also be used by any of the firefighting devices described herein such as firefighting devices 100, 150, 160, 200, 230, 240, or any alternatives thereof, in accordance with the teachings herein, to control operation thereof.

The control unit 310 includes a processor unit 400 having a processor 402, a memory 404 that stores software instructions for one or more control programs 405, an input interface 406, and a control interface 408. The control unit 310 also includes communication hardware 410. In at least one embodiment, the control unit 310 may further comprise a positioning unit 412. The processor unit 400 is communicatively coupled to the memory 404, the input interface 406, the control interface 408, and the communication hardware 410 via one or more communication busses (not shown). It should be understood that there is also a power supply unit 414 which receives power from an energy source 416 and provides power signal conditioning and distributes the conditioned power signal to the various components of the control unit 310 and some of the other hardware elements shown in FIG. 4 via one or more power busses (not shown). In alternative embodiments, the control unit 310 may include different components as long as the same functionality is provided.

The processor unit 402 includes at least one processor 402 that can provide sufficient processing power depending on the configuration and operational requirements of the firefighting device 100, 150, 160, 200, 230, 240 or any alternatives thereof. For example, the processor unit 400 may include a high-performance processor and/or it may contain processors that are directed towards performing different functions. The processor 402 executes software instructions that are stored on the memory 404 which configures the processor 402 to perform certain functions for controlling the operation of the firefighting device 100, 150, 160, 200, 230, 240 or any alternative thereof as is described further below.

The input interface 406 can be any input mechanism that can be used by a user to provide inputs to the processor 402. For example, the input interface 406 may comprise one or more switches, one or more knobs, one or more sliders, one or more buttons or one or more touchscreens. Alternatively, an operator may provide inputs to the processor 402 via the communication hardware 410 as is further explained below.

In at least one embodiment, the input interface 406 may include network hardware having at least one network port to allow the processor 402 to communicate with any remote computing devices as described herein. The network hardware may allow the processor 402 to communicate via the Internet, a Local Area Network (LAN), a Wide Area Network (WAN), a Metropolitan Area Network (MAN), a Wireless Local Area Network (WLAN), a Virtual Private Network (VPN), or a peer-to-peer network. The network hardware may include a router, a switch, a hub or other routing device.

The control interface 408 may be a collection of hardware elements that allow the processor 402 to communicate with other elements of the firefighting device 100, 150, 160, 200, 230, 240 or alternatives thereof that are physically separate from the control unit 310 such as, but not limited to, the actuator 308, the temperature sensor 316, the CFS 250 (or another system used for creating the firefighting agent and discharging the firefighting agent), the camera 420, the valve(s) 418, a wind sensor 422, an air quality sensor 424 and/or a display 426. Some of these sensors may be optional in some embodiments. For example, the control interface 408 may include at least one of a serial bus, a parallel bus, or other communication lines along with one or more ports such as a parallel port, a serial port, and/or a USB port. The control interface 408 also typically includes one or more Analog to Digital converters (ADCs) or a multichannel ADC when digital control signals from the processor 402 are provided to analog components within the firefighting device 100, 150, 160, 200 or 230. The control interface 408 may also include one or more Digital to Analog converters (DACs) or a multi-channel DAC when analog data signals from certain hardware elements of the firefighting device 100, 150, 160, 200 or 230, such as a temperature signal from the temperature sensor 316, are converted into digital signals and sent to the processor 402.

In at least one embodiment, the control unit 310 may alternatively or additionally include various communication hardware 410 for allowing the processor 402 to communicate with remote devices. For example, the communication hardware 410 may include a Bluetooth radio or other short range communication device and/or a long-range communication device such as, but not limited to, a wireless transceiver for wireless communication according to a suitable communications protocol such as CDMA, GSM, or GPRS protocol using standards such as IEEE 802.11a, 802.11b, 802.11g, or 802.11n. In such embodiments, the communication hardware 410 may allow an operator to access the control unit 310 via a software application that is operated on a smartphone, a desktop, a laptop or a server and provide inputs, such as control inputs, to the control unit 310 and/or access operational data and/or environmental data stored on the memory 404 such as, but not limited to, the amount of remaining firefighting agent, or temperature and/or wind direction measurements of the operational region, for example.

In at least one embodiment, the control unit 310 may further comprise a positioning unit 412. The positioning unit 412 may comprise a receiver for receiving satellite positioning signals, such as signals received from GPS, GLONASS, Galileo, BeiDou, QZSS, IRNSS and or NavIC satellite networks. The positioning unit 412 determines location data of the firefighting devices described herein and provides the location data to the processor unit 400. The location data can be stored on the memory 404 and/or sent to any remote computer devices as described herein to allow for tracking the position of the firefighting device 100, 150, 200, 230, 240 or alternatives thereof.

The power supply unit 414 includes power signal conditioning and isolation circuitry such as one or more voltage regulators and/or converters as well as surge protectors for receiving a power signal from the energy source 416 and generating voltage supply signals for use by various hardware elements shown in FIG. 4. The voltage regulator(s) may be used to provide constant voltage supply levels at different levels since various hardware elements shown in FIG. 4 require constant supply voltages and may operate at different supply voltage levels. The surge protector is used to prevent damage to any circuit boards and circuit components used by the various hardware elements shown in FIG. 4. The power supply unit 414 may be a commercially available unit that provides sufficient power capabilities to power and provide electrical protection for various hardware elements shown in FIG. 4.

The energy source 416 may be any suitable portable energy source such as one or more batteries, which may or may not be rechargeable and may have a power management system (known to those skilled in the art).

The actuator 308 is operatively coupled to the moveable mount 304 that is in turn attached to the nozzle 120 of the firefighting devices described herein. The actuator 308 is adapted to move the moveable mount 304 in a horizontal manner, a vertical manner, or a horizontal and/or vertical manner. The actuator 308 may be implemented using two or more motors such as two or more servo motors, for example, as previously described. In embodiments where there are multiple nozzles, there may be corresponding actuators that are used to control the movement of those nozzles. Also, there may be other actuators and/or switches that are used for opening and closing doors or flaps such as those described for firefighting devices 230 and 240, for example.

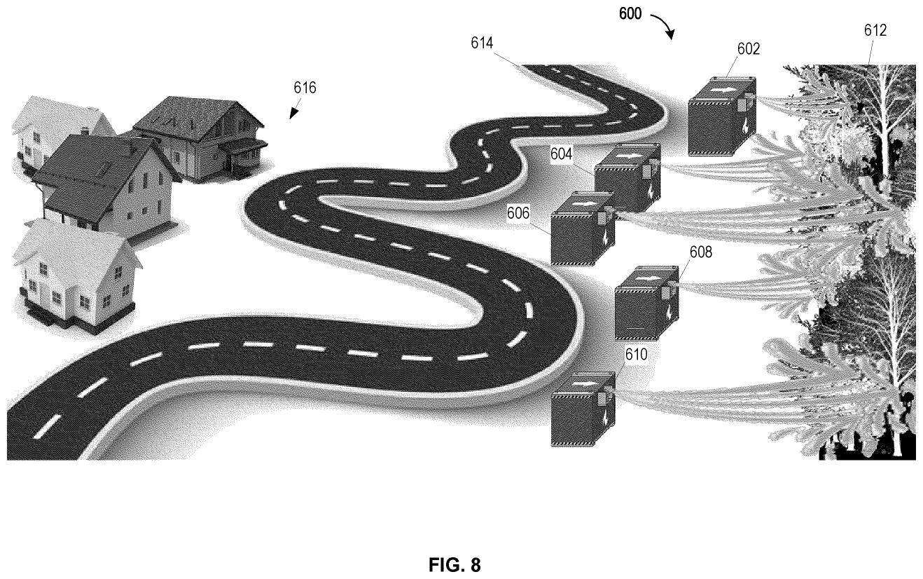

During use, the processor 402 generates an actuator control signal that is sent to the actuator 308 to control the actuator 308 to move the moveable mount 304 so that the nozzle tip 302 is moved in a desired manner. For example, the actuator control signal may be generated by the processor 402 so that the nozzle tip 302 is moved in a predefined manner which may be a horizontal manner such as a side-to-side motion, a vertical manner such as an up and down motion, or a combination of horizontal and vertical movements for following a certain pattern such as a circular, an elliptical, a FIG. 8, a Z shaped or a zig-zag pattern, for example. The actuator control signal may be generated based on selecting one of the predetermined patterns that are stored in the memory 404 or the actuator control signal may be generated based on temperature measurements made using an infrared sensor like an infrared camera in order to target a certain portion of the fire as is described herein or a combination of both. This functionality allows the firefighting devices 100, 150, 160, 200, 230, 240 or any alternative thereof to operate in an autonomous manner by making measurements and then autonomously deploying the firefighting agent and moving the nozzle tip 302 based on a predetermined pattern or a calculated pattern. The predetermined pattern can be determined to control the nozzle tip 302 to move in directions that may more effectively combat the fire at hand.

In at least one embodiment, the processor 402 may also generate the actuator control signal such that it is able to controllably set the speed of motion of the nozzle tip 302 as it is moved in a desired manner/direction and/or the size of the opening of the nozzle tip 302 to make the spray pattern of the discharged firefighting agent wider or narrower.

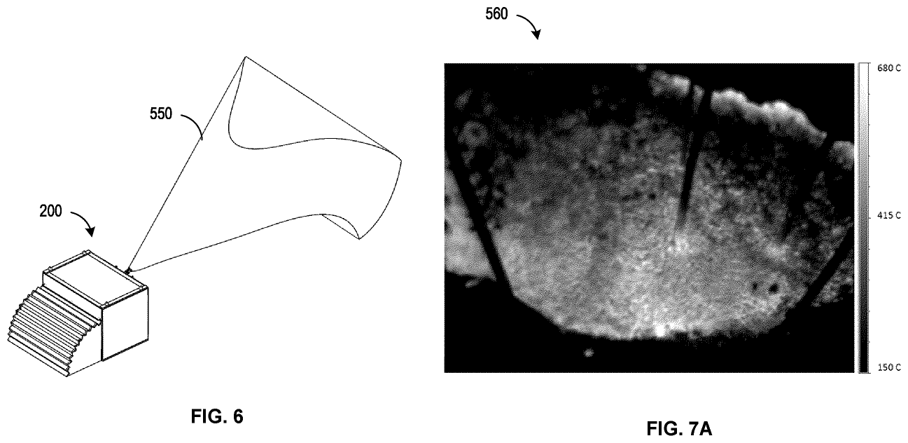

In at least one embodiment, the firefighting agent discharge system is automated and operates autonomously. In such embodiments, the temperature sensor 316 measures temperature data in a region that is proximal to the firefighting devices described herein. The measured temperature data is then analyzed by the processor 402, which may be done by comparing the measured temperature data with a temperature threshold. When the processor 402 determines that the measured temperature data exceeds the temperature threshold, which may occur (a) when only one measured temperature data point exceeds the temperature threshold or (b) when a predefined number of measured temperature data points either successively or collectively, in a certain time period, exceed the temperature threshold, in which case the processor 402 generates a valve control signal to move the valve 418 to an open position which causes the propellant system to autonomously deploy the firefighting agent. At the same time the processor 402 can generate the actuator control signal to control the actuator 308 to move the nozzle tip 302 in a desired manner. FIG. 6 provides an example of the firefighting device 200 deploying the firefighting agent 550.

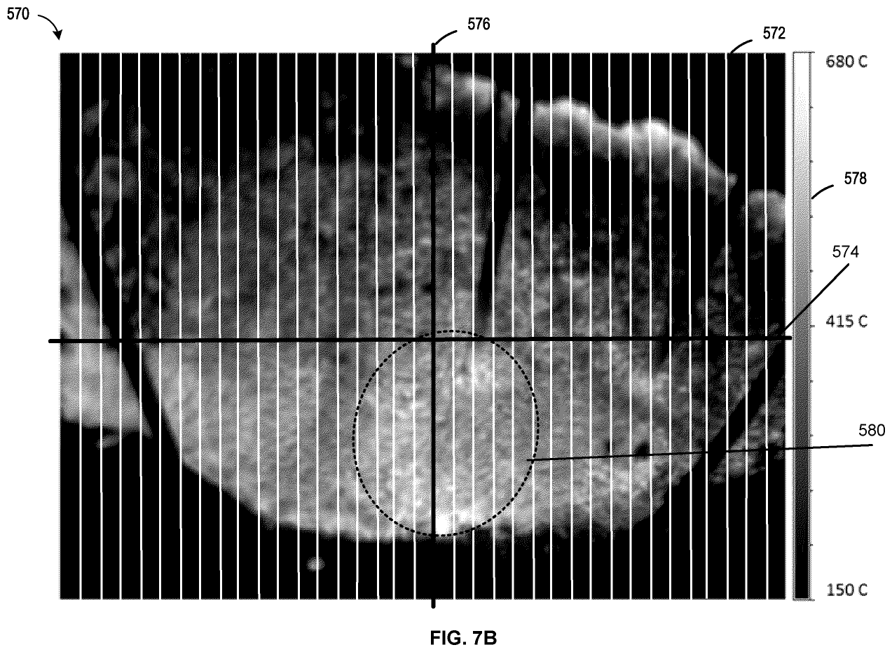

In at least one embodiment, the temperature sensor 316 may be implemented such that it is possible to determine the hottest area of a fire that may be in the operational region of the firefighting devices described herein or a region adjacent the operational region depending on the range of the temperature sensor 316. For example, the temperature sensor 316 may be a thermal camera that records data that may be used to generate a thermal image showing the temperature variation of an area that may be in the operational region. FIG. 7A provides an example of a thermal image 560. The thermal image may be a high-resolution thermal infrared image that shows the temperature of a fire front according to a thermal scale.

The thermal image 560 may then be analyzed by the processor 402 using image analysis techniques to determine an area of the proximal region with the hottest temperatures and compare the average or maximum temperature of the determined area (having the hottest temperatures) with the temperature threshold. When the processor 402 determines that the maximum or average temperature of the determined area exceeds the temperature threshold, which may occur (a) when only one measured temperature data point exceeds the temperature threshold or (b) when a predefined number of measured temperature data points either successively or collectively, in a certain time period, exceed the temperature threshold, then the processor 402 generates a valve control signal to move the valve 418 to an open position which causes the propellant system to autonomously deploy the firefighting agent. At the same time the processor 402 generates the actuator control signal to control the actuator 308 to move the nozzle tip 302 in the direction of the determined area.

The thermal image analysis may be done by locating the cells of a grid to different regions of a thermal image in order to perform calculations at different locations on the thermal image. For example, referring now to FIG. 7B, shown therein is an example an infrared image 570 with a superimposed grid 572 to illustrate how calculations at the locations of certain cells of the grid may be used for automatic deployment of the firefighting agent during operation of one of the firefighting devices described herein or any alternative thereof. For example, the grid is oriented along an x axis 574 and a y axis 576 that can be used to determine the coordinates of cells within the grid 572 that have the highest temperatures based on using the temperature scale 578. For example, the cells that are within the region 580 may be determined to be the hottest areas of the fire in the image 570. The cells within the region 580 may be determined by finding cells that have the highest temperature where the cells are adjacent to one another. The x and y coordinates for these cells are then used to determine the boundary for a movement pattern to move the nozzle tip 320 during deployment of the firefighting agent towards the hottest areas of the fire. For example, the neutral or home position of the nozzle tip 320 may correspond to the origin or (0, 0) coordinate on the grid 582. The firing end of the nozzle tip 320 can then be directed to the coordinates of the cells within the region 580 relative that are located relative to the (0, 0) coordinate (e.g., the home position of the nozzle tip 320).

In at least one embodiment, the movement pattern for the nozzle tip 320 may be predetermined and stored in the memory 404 and the predetermined movement pattern may be applied to the cells in the region 580. For example, the pattern may be a “bottom up” pattern where the lower positioned hottest areas of the fire are provided with the firefighting agent first. This technique of determining the hottest region of the fires and directing the firefighting agent to the hottest region is advantageous as this is a more effective way to fight the fire rather than the conventional way of dropping a firefighting agent from the air via an airplane where the firefighting agent is not likely to reach or be concentrated in the hottest areas of the fire first which is more of a top-down approach.

In at least one embodiment, the movement pattern for the nozzle tip 320 may be determined by first determining a heat pattern from a thermal image obtained by the thermal camera 420, determining the hottest regions of the fire from the thermal image, retrieving various predetermined movement patterns that are stored in the memory 404, determining correlation values between the predetermined movement patterns and the hottest regions of the fire to determine which movement pattern will have better coverage (e.g. better overlap) for the hottest regions of the fire based on the movement pattern having the highest correlation with locations of the hottest regions of the fire, and then moving the nozzle tip 320 according to the determined movement pattern.

Alternatively, in at least one embodiment, there may be a movement pattern for the nozzle tip 320 that may be determined by the processor or a human operator by selecting one of a plurality of movement patterns that are stored in memory where the selection is based on at least one characteristic of the fire. The determined movement pattern may then be used to control the actuator to move the nozzle tip 320 according to the selected movement pattern. In addition to selecting a movement pattern based on the hottest area of a fire, other characteristics of a fire that can be used for selecting the movement pattern include, but are not limited to, a leading edge (i.e., fire front) of the fire growth to prevent the fire from spreading, a location that the fire is moving towards, an area close to the fire where there is a “fire fuel source” that can make the fire grow more quickly where examples of the fire fuel source are highly combustible material, dry trees or grass, gas, and oil; or an area of fastest movement of the fire, for example.

In at least one embodiment, the movement pattern for the nozzle may be determined periodically during usage so that as the heat pattern of the fire changes during operation of the various portable firefighting devices described herein, the movement pattern that provides the most effective coverage (e.g. the best overlap) for the hottest regions of the fire can be determined (after the heat pattern is determined as described previously) and then moving the nozzle tip 320 according to the determined movement pattern.

Alternatively, in at least one embodiment, the firefighting device 100, 150, 200, 230, 240 or any alternative thereof can be remote controlled so that a firefighter does not have to be put into the line of sight of a fire and be in danger. In such embodiments, an operator may remotely control the operation of the firefighting devices described herein including deploying the firefighting agent and moving the nozzle tip 320 of the nozzle 120 by providing control signals from a remotely located computing device. In such cases, the grid pattern 572 and infrared image 570 can be displayed to the operator so that the operator is able to correctly direct the nozzle tip 320 to deploy the firefighting agent to the hottest regions of the fire.

In at least one embodiment, several thermal images may be obtained across time. These thermal images may then be analyzed by the processor 402 to determine rate of flame spread, fire intensity and temperature.

In at least one embodiment, when the firefighting agent is being discharged, the fire may be monitored by monitoring temperature of the fire or a thermal image of the fire, as explained previously using the temperature sensor 316 and/or thermal camera 420 to determine when the fire is under control or is snuffed out. When that is determined, the deployment of the firefighting agent may be deactivated, such as by moving the valve 418 to an off position. In other embodiments, the firefighting agent may continue to be deployed until it is finished.

While the firefighting agent is being discharged, the firefighting device 100, 150, 160, 200, 230, 240 or any alternative thereof may continue to send measured environmental data to the remote computing device. Once the firefighting agent is depleted, the deployment of the firefighting agent may be stopped but the firefighting device 100, 150, 160, 200, 230, 240 or any alternative thereof may continue to send measured environmental data to the remote computing device until the portable firefighting device is retrieved and/or its energy source 416 is depleted.

In at least one embodiment, the firefighting device 100, 150, 200, 230, 240 or any alternative thereof may also include the wind sensor 422 that is used to measure wind direction and/or wind magnitude data for the region that is proximal to the portable firefighting 100 or 200. The wind sensor 422 may use a weather vane to measure wind direction. The wind sensor 422 may use an anemometer to measure wind strength (i.e., wind magnitude). The measured wind direction and/or wind magnitude data is sent to the processor 402 which may then transmit the wind direction and/or wind magnitude data using the communication hardware 410 to any remote computing devices as described herein.

In at least one embodiment, the wind direction and/or wind magnitude data that is measured by the wind sensor 422 may be used by the processor 402 to adjust an output setting (e.g., head setting) on the nozzle 120 to change the amount and pattern of the firefighting agent that is ejected/sprayed/deployed by the nozzle so that the spray pattern is widened or narrowed compared to a previous setting. This may be done to ensure that a required spray distance is being achieved based on the prevailing winds. For example, if the prevailing winds become stronger, the output setting of the nozzle 120 may be adjusted so that the spray pattern becomes narrower and is able to withstand the increased wind strength.

In at least one embodiment, the firefighting device 100, 150, 160, 200, 230, 240 or any alternative thereof may also include the air quality sensor 424, which is optional. The air quality sensor 424 is used to measure air quality data for the region that is proximal to the portable firefighting devices described herein. The air quality sensor 424 may be implemented using know air pollution sensors. The measured air quality data is sent to the processor 402 which may then transmit the air quality data using the communication hardware 410 to any remote computing devices as described herein.

In at least one embodiment, the firefighting device 100, 150, 160, 200, 230, 240 or any alternative thereof may also include the display 426, which is optional. The display 426 may be located on a surface of the housing 102 such as a rear surface of the firefighting device 100, 150, 160, 200, 230 or 240 or any alternative thereof, for example, and may be implemented using an LCD or OLED screen. In at least one embodiment, the display 426 may be a touchscreen and the processor 402 may be configured to generate and display a Graphical User Interface (GUI) to provide various data to the firefighter 208 or other user of the firefighting device. In addition, in some embodiments, the GUI may be implemented such that it allows the firefighter 208 or other user, such as a remote user who may not be at the location of the fire and may be at a central command center for example, to provide inputs including values for operational parameters and/or control inputs to the processor 402 to control the operation of the portable firefighting device 100, 150, 160, 200, 230, 240 or any alternative thereof.

Accordingly, the various firefighting devices described herein may operate under three modes of operation including an autonomous mode, a remote mode and a manual mode. In the autonomous mode of operation, the various firefighting devices described herein take temperature measurements of its surrounding region (i.e., operational region and/or farther adjacent region) and then autonomously deploys the firefighting agent in various manners as described herein. In remote operation mode, the various firefighting devices described herein receive control signals from a user who is remote to the location of the fire and remotely controls the firefighting devices to fight the fire. In manual operation mode, the various firefighting devices described herein have control input devices that are located on their housing, or an accessible interior surface, and a firefighter can interact with these control input devices to control the operation of the firefighting device as described herein.

In at least one embodiment, the display 426 may be used by the firefighter 208 to view a thermal image of a portion of the operational region as well as any other measurement data that is being obtained by the various sensors including (a) temperature data, (b) wind direction and/or wind magnitude data and/or (c) air quality data. The images and other data may be used by the firefighter 208 to determine the severity of any fires in the operational region, to determine how and when the fires may be changing in strength and/or direction and/or to determine how poor the air quality is. All of this data may also be transmitted to any remote computing device, as described herein, for remote monitoring of operational data and environmental data for any fires in the operational region.

Also, the air quality data may be used to determine when the firefighter 208 needs to wear a mask that may optionally be connected to an oxygen source at the portable firefighting device 100, 150, 160, 200, 230 or 240 or any alternatives thereof so that the firefighter 208 can safely breath. The oxygen source may be oxygen tanks within the portable firefighting device 100, 150, 160, 200, 230 or 240 or any alternatives thereof that can be used by the firefighter 208 in particularly dangerous conditions where air quality is very poor.

The memory 404 stores program instructions for an operating system and the control program(s) 405. When the program instructions for the control program(s) 405 are executed by the processor 402 of the processor unit 400, the processor 402 is configured for performing certain functions in accordance with the teachings herein.

For example, the control program(s) 405 generally include program instructions that, when executed by the processor 402, configure the processor 402 to engage in a monitoring mode of operation where measurement data is obtained by the various sensors that are included with the portable firefighting devices described herein, and images are obtained from the camera 420. The measured data and images may then be stored on the memory 404 and/or transmitted to the remote computing device where this transmission occurs periodically or in real-time.

As another example, the control program(s) 405 includes program instructions that, when executed by the processor 402, configures the processor 402 to engage in an automatic deployment mode where measured temperature data and/or thermal image data may be obtained and compared to a threshold for automatic deployment of the firefighting agent as previously described herein.

Alternatively, as another example, control program(s) 405 includes program instructions that, when executed by the processor 402, configures the processor 402 to engage in a remote deployment mode or a manual deployment mode of the firefighting agent as described previously.

Referring now to FIG. 5, shown therein is a flow chart of an example embodiment of a method 500 of operating a firefighting device in accordance with the teachings herein, such as the firefighting device 100, 150, 160, 200, 230, 240 or alternatives thereof. It should be noted that in other embodiments, there may be other steps or some of the steps may be ordered differently.

At 502, the method 500 comprises measuring a temperature of a portion of the operational region of the firefighting device using a temperature sensor such as the temperature sensor 316 or using thermal image data from a thermal camera 420 as explained previously. In an alternative embodiment, other environmental data may be measured during this step and the measured data may be stored and/or transmitted to a remote computing device as described herein.

At 504, the method 500 comprises determining whether the measured temperature is greater than a temperature threshold. This may be done based on more or more measured data points as described previously. If the determination is false, then the method 500 returns to 502 where the temperature is further monitored. However, if the determination is true then the method 500 proceeds to 506.

At 506, the method 500 comprises autonomously deploying the firefighting agent from the nozzle 120 of the firefighting device towards the operational region when the measured temperature exceeds the temperature threshold. The discharge may be performed according to any one of the techniques described herein. For example, a grid pattern along with an infrared image may be used to determine the locations of the fire that are larger than the temperature threshold or to determine the hottest regions of the fire as explained previously, and the nozzle 120 may then be moved (a) in a vertical and/or horizontal manner, (b) in a predetermined pattern such as a circular, an elliptical, a figure-8 or a zig zag pattern, (c) in a manner so that the nozzle 120 is directed to a hottest area of a fire in a region that is proximal to the portable firefighting device, (d) at a faster or slower speed and/or (e) with a wider or narrower spray pattern that may change over time as the fire and/or wind changes.

At 508, the method 500 comprises measuring other environmental data depending on the sensors that are included in the firefighting device. For example, one or more of measured temperature data, images of portions of the operational region, a location of the firefighting device, wind direction and/or wind magnitude data for the operational region and/or air quality data for the operational region may be obtained.

At 510, the method 500 comprises sending one or more of the measured data items to a remote computing device, which may be done for remotely monitoring the operation of the firefighting device, monitoring environmental data of the environment (e.g., operational region) of the firefighting device and/or monitoring the location of the firefighting device.

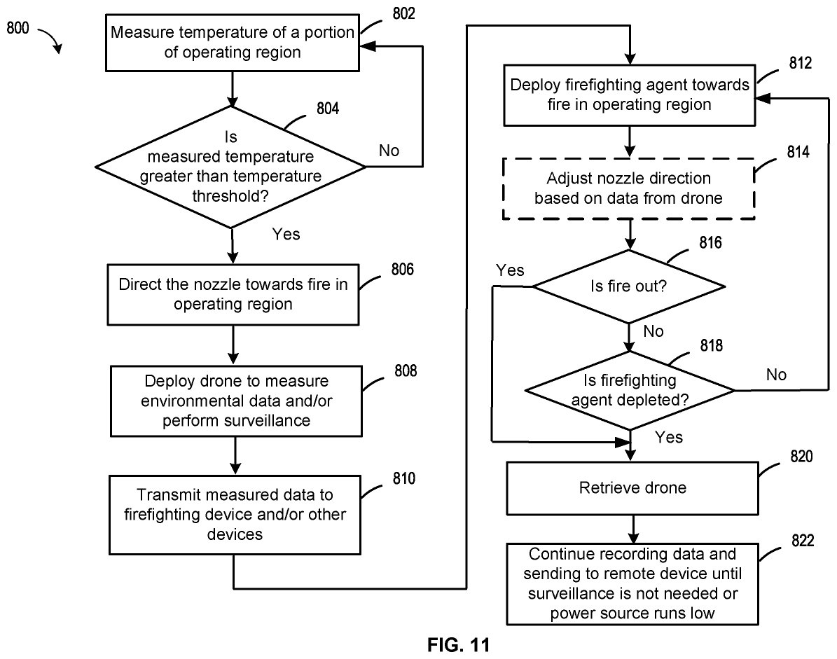

Referring now to FIG. 11, shown therein is a flowchart of an example embodiment of a method of operating a firefighting device that contains a drone as described in accordance with the teachings herein, such as for firefighting device 230 or an alternate thereof, for example.

At step 802 of the method 800, temperatures are measured by a temperature sensor, such as the temperature sensor 316. The temperature sensor 316 may be mounted to the nozzle tip 320. The temperature sensor 316 may be a thermal imaging device such as, but not limited to, a Mid-Wave Infrared Red (MWIR) camera, for example, which provides image data indicative of temperature in the field of view of the camera. Alternatively, or in addition to the thermal imaging device, the temperature sensor 316 may include a temperature/heat detector that provides a series of measured temperature values taken over time. The measured temperature data, which may include thermal image data and/or temperature values, is sent to the processor 402. The method 800 then proceeds to step 804.

At step 804 of the method 800, the processor 402 determines whether the measured temperatures are indicative of a fire which may be done by compared the measured temperatures to a first temperature threshold as explained previously. The method 800 then proceeds to step 806.

At step 806 of the method 800, after the processor 402 has determined that there is a nearby fire, the processor 402 sends control signals to position the nozzle tip towards the hottest section of the heat source (e.g., fire) which may be determined as explained previously. The method 800 then proceeds to step 808.

At step 808 of the method 800, the drone 234 is deployed. In this step, the processor 402 sends control signals to the flaps or doors 236 (also known as drone bay doors 236) to open. The processor 402 then sends control signals to the drone 234 to initiate lift off. The processor 402 then sends control signals to the drone bay doors 236 to close. At this point the drone 234 can be operated to perform surveillance on the environment by measuring various environment conditions, obtaining images and/or a video stream of the environment. The method 800 then proceeds to step 810.

At step 810 of the method 800, the measurements, images and/or video stream obtained by the drone can be sent to: (a) the firefighting device from which the drone was launched, (b) a central surveillance/command center and/or (c) to mobile devices that are operated by firefighters who can then use this data in combatting the fire. The method 800 then proceeds to step 812.

At step 812 of the method 800, the processor 402 sends an actuation control signal to create and deploy the firefighting agent. The method 800 then proceeds to step 814.

At step 814, which is optional, the images transmitted from the drone 234 to the firefighting device may be used to improve the accuracy of the deployment of the firefighting agent due to the bird's eye view provided by the drone. For example, in certain situations the thermal imaging obtained by the temperature sensor on the firefighting device may be limited. In such cases the drone 234 may be used to extend the “vision” of the firefighting device because it can move and provide images showing a bird's eye view of the fire and the direction in which the fire is travelling may be determined from successively obtained images therefore enabling the portable firefighting device with data that can be used to adjust the direction of the nozzle so that it delivers the firefighting agent to one or more important areas of the fire that needs to be fought. This may be done by the provision of a correction factor based on the data obtained by the drone 234 and transmitted to the firefighting device. For example, the processor of the firefighting device may determine differences between thermal images obtained by the drone with thermal images obtained by the firefighting devices and generate the correction factor based on these differences. The correction factor can then be applied to adjust the control signals that are used to move the direction of the nozzle.

In an alternative embodiment, a human operator, such as a fire fighter, at a central command can remotely take over and position the nozzle based on the images that they are provided with. The images being seen by the command center may provide information that the operator can use to redirect the foam distribution to a more important point in the fire that needs to be addressed in order to put out the fire or prevent further spread to a certain area rather than a different area that the firefighting device may have identified. In such cases, the human operator can override the autonomous deployment of the firefighting agent.

At step 816 of the method 800, the temperature sensor is used to measure temperatures which are then sent to the processor 402. If the processor 402 determines that the measured temperatures are below a second temperature threshold, the processor 402 then determines that the fire has been put out in which case the method 800 proceeds to step 820. If the measured temperatures do not indicate that the fire is out, then the method 800 proceeds to step 818.

At step 818 of the method 800, once the compressed air reaches a pre-set pressure threshold (which may be digitally set) which is equal to the complete depletion of the firefighting agent, the processor 402 sends a control signal to stop the deploying of the firefighting agent, which may be done by moving the solenoid/valve to the closed position. The method 800 then proceeds to step 820.

At step 820 of the method 800, the processor 402 can then send control signals so that the drone 234 is retrieved. This involves sending control signals to open the drone bay doors 236. The drone 234 returns to the firefighting device for storage (e.g., at a home position) within the interior of the firefighting device. The processor 402 may then verify that the drone 234 is secure and sends another control signal to close the drone bay doors 236. The method 800 then proceeds to step 822.

At step 822 of the method 800, the temperature sensor, the camera and/or other sensors are still recording data which is then sent by telemetry to a remote device until surveillance is no longer required or the power source of the firefighting device reaches a low threshold setting. The method 800 may then end.

In an alternative embodiment, the method may involve first deploying the drone 234 to perform surveillance in the v operational region and/or regions adjacent to the operational region and farther away (i.e., farther adjacent region) from the firefighting device. The drone 234 may obtain image data which may then be analyzed by a processor of the drone, using techniques similar to at least one technique employed by the onboard processor of the firefighting device, or other techniques described below, to detect a condition where the firefighting agent should be deployed and then send a control signal to the firefighting device to deploy the firefighting agent which may be done by moving the nozzle according to a pattern which may be selected from one of several predetermined patterns according to techniques described herein. In some cases, the drone 234 may be launched according to a launch schedule as described herein.

As mentioned previously, one or more controllable valves (or gates) may be used to mix the source material with the gas and optionally water for creating and deploying the firefighting agent through the nozzle 120 during use. For example, the controllable valve(s) may be autonomously controlled based on detection of a condition such as a fire having a certain amount of heat that is sensed and is in the operational region or is headed toward the operational region of the firefighting device 100. The condition may be automatically detected based on one or more algorithms that analyze data measured by one or more sensors of the firefighting device 100 or the drone 234 such as one of the algorithms described herein. Alternatively, or in addition thereto, a control signal might be remotely provided for deployment of the firefighting agent from a remote control system that communicates with the firefighting device 100 through a communication network. In yet another alternative, or in addition thereto, one or more input buttons on the housing of the firefighting devices described herein or a handheld control device may be pressed by a firefighter who is adjacent to the firefighting device and deploying the firefighting agent.

In at least one embodiment, the firefighting agent may be deployed in a proactive manner before the actual fire reaches the vicinity of the firefighting devices described herein. This may be done through various mechanisms which may be automated or manual. For example, for firefighting devices with a drone 234, the drone 234 can be deployed and provide measurement data and/or images that may be analyzed to detect fires that are about to enter into a given area of the operational region of the firefighting device in which case the firefighting agent may be deployed to cover the given area of the operational region before the fire arrives. This proactive deployment of the firefighting agent prevents the ability of the fire to use objects, such as brush and wood, for example, in the sprayed region as fuel to stop the advance of the fire. The analysis of the data obtained by the drone 234 may be done by a processor on the drone 234 which then sends an activation signal to a processor at the firefighting device for autonomously deploying the firefighting agent. Alternatively, the processor at the firefighting device may perform this analysis to autonomously deploy the firefighting agent in these cases. The drone 234 may also have a larger range than any imaging device that is employed by the firefighting device allowing for imaging data for distances that are further away from the firefighting device to be obtained and analyzed, which aids in deploying the firefighting agent more proactively (e.g., quicker deployment).

The analysis that is employed by the drone 234 or the onboard processor of the firefighting device to proactively deploy the firefighting agent may be based on analyzing successive frames of thermal image data. In each thermal image, edge analysis may be performed to determine the location of the leading edge of the fire (i.e., the fire front). This may be done by employing various image processing techniques such as edge detection, for example. In at least one embodiment, the location of the fire front can be determined and compared to a predetermined distance threshold, which may be defined relative to the maximum of the operational region of the firefighting device. Once the fire front advances over the predetermined distance threshold, the firefighting agent may be autonomously deployed. This automated deployment may also take time into consideration such as the amount of time to deploy the firefighting agent and the speed of the fire front. Accordingly, in at least one embodiment, the speed of the fire front may be determined by measuring how quickly the fire front moves based on its position across successive images and the elapsed time between when those images were obtained. The speed of the fire front may be compared to a speed threshold and used to deploy the firefighting agent earlier when the fire front is moving more quickly.

Another way for firefighting devices to operate proactively, even if they do not use a drone, can be through the manual operation of the firefighting device by an operator who is providing control inputs to the firefighter device. This may be done when the operator is a firefighter that is located at the firefighter device, or the operator is a remote user who is controlling the firefighting device wirelessly from a remote location. In these cases, the firefighting agent may be deployed based on the location of the fire front and optionally the speed of the fire front as described previously.

Alternatively, in at least one embodiment, the firefighting agent may be deployed in a reactive manner when the fire is closer to the firefighting device and may be triggered by the analysis of data provided by a sensor at the firefighting device. For example, the sensors employed at the firefighting device may be more short-range compared to the sensors used by a drone and so fires may be detected later within the operational region of the firefighting device and the firefighting agent may be autonomously deployed using one of the techniques described herein. Alternatively, the firefighting devices may be operated manually by a firefighter or other operator as described previously but in the case where a fire has just started in the operational region.

In another aspect, a plurality of the firefighting devices 100, 150, 200, 230 or any alternatives thereof may be deployed in a given area for fighting a fire and/or protecting other structures and/or people from fire. For example, referring now to FIG. 8, shown therein is a deployment 600 of firefighting devices 602 to 610 that are positioned between a fire front of a forest fire 612, and a roadway 614 and houses 616. The firefighting devices 602 to 610 may be implemented according to any one or more of the embodiments described herein. The firefighting devices 602 to 610 may be placed in desired positions by a helicopter or a forklift according to a desired arrangement. A larger or fewer number of the firefighting devices 602 to 610 may be deployed as needed based on the severity of the forest fire. The firefighting devices 602 to 610 may then be operated autonomously or by remote control as described previously.

Accordingly, the firefighting devices described in accordance with the teachings herein may be used to save insurance companies million in dollars if the portable firefighting devices were deployed around communities or structures in the line of incoming fires. For example, any of the firefighting devices described herein may be placed alongside a highway that is used for evacuation purposes.

Referring now to FIG. 9, shown therein is an example embodiment of a firefighting system 700 that incorporates a plurality of firefighting devices 704a to 704n that are in communication with a server 702 through a communication network 706, such as a wireless communication network. The firefighting devices 704a to 704n may be implemented according to any of the embodiments described herein. The firefighting devices 704a to 704n are configured to measure operational and/or environmental data and send this data to the server 702.

The server 702 comprises a processor unit 708 having a processor 710, a memory 712 for storing program instructions for various programs including a monitor/control program 714, communication hardware 716 and a display 718 as well other hardware components (not shown) used for operation as is understood by those skilled in the art. The processor unit 708, processor 710, memory 712, monitor/control program 714, communication hardware 716 and display 718 may be implemented in a similar fashion as the processor unit 400, processor 402, memory 404, control program 405, communication hardware 410 and display 426.

The communication hardware 716 is configured for receiving the operational and/or environmental data from the plurality of firefighting devices 704a to 704n and any drones that were launched from any of the firefighting devices 704a to 704n. The processor 708 is communicatively coupled to the memory 712 and the communication hardware 716 and, when executing software instructions from the monitor program 714, is configured to process any received operational and/or environmental data and display at least some of this data in a graphical form on the display 718.

The operational data from each of the firefighting devices 704a to 704n may include data on the power level of their energy sources 416 and/or the supply of their firefighting agents. The environmental data provided by the firefighting devices 704a to 704n may include one or more of measured temperature data, images of the operational region, locations, wind direction and/or wind magnitude data for the operational region, air quality data for the operational region, additional line of sight video feeds and/or other data provided by one or more of the drones.

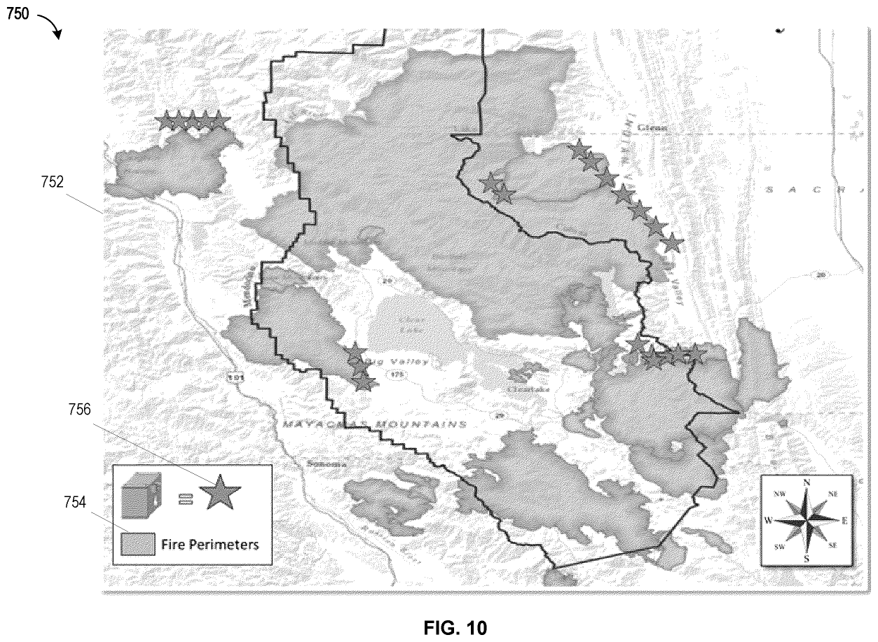

For example, the processor 710, by executing the monitoring/control program 714, may be configured to generate a map of the deployment region (where the firefighting devices are located) and include the data received from the plurality of firefighting devices 704a to 704n superimposed on the map. For example, referring to FIG. 10, there is shown a map 750 of an underlying region 752 with fire perimeters 754 shown as well as the locations 756 of the firefighting devices.

In an alternative embodiment, the processor 710 may be configured to generate the map 750 of the region 752 so that the map 750 includes the temperature data at the locations 756 of the plurality of firefighting devices. Alternatively, or in addition thereto, in at least one embodiment, the processor 710 may be configured to generate the map 750 of the region 752 so that the map includes the wind direction and wind magnitude data at the locations 756 of the plurality of firefighting devices. Alternatively, or in addition thereto, in at least one embodiment, the processor 710 may be configured to generate the map 750 of the region 752 so that the map includes the air quality data at the locations 756 of the plurality of firefighting devices.

In at least one embodiment, the data from the firefighting devices 704a to 704n may be received periodically and the processor 710 is configured to update the generated map 750 of the region 752 with the periodically received data.

Alternatively, in at least one embodiment, the data from the firefighting devices 704a to 704b is received in real time and the processor 710 is configured to update the generated map 750 of the region 752 with the received data in real time or periodically.

The receipt of the data can be used to understand which direction the fire is moving in and also see in real time where the firefighting devices 704a to 704n are deployed. The server 702 may provide this data and any generated maps to a command centre where officials can make decisions on how to deal with a wildfire without putting firefighting personnel in danger. For example, one or more of the firefighting devices 704a to 704n may be repositioned, their energy sources 416 recharged and the supply of firefighting agent replenished when needed. Conventional surveillance techniques rely on obtaining visuals from helicopters to determine where a fire is heading. However, the surveillance provided by the firefighting devices 704a to 704n and/or any of their drones is more effective since these devices are directly in the environment that is being monitored and they provide real-time or near real-time telemetry data which is important in being able to effectively coordinate a strategy to deal with a wildfire.

In addition, the monitoring/control program 714 may be used to remotely control the operation of the portable firefighting devices 704a to 704n, depending on the environmental conditions that are measured, to address and retard the progression of the fire, as described previously, thereby allowing for the implementation of remote firefighting.

In at least one alternative embodiment, the base of any of the portable firefighting devices described herein may be rotatable in that the base includes a rotation mechanism such as a circular track or ring and an actuator such as a stepper motor, for example, with enough power to overcome any inertia due to the weight of the firefighting device in order to rotate the firefighting device. The rotation mechanism is coupled to the base member and the actuator is coupled to one or more portions of the outer frame to which the housing 102 is mounted so that when the actuator moves the housing 102 of the firefighting device may also rotate which provides for a greater range of motion of the nozzle tip allowing the portable firefighting device to fight fires along a greater circumferential range.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An autonomous firefighting device, wherein the device comprises:
a housing;
at least one tank disposed within the housing, the at least one tank containing source material for a firefighting agent;
a propellant system that is contained within the housing and operatively coupled to the at least one tank for deployment of the firefighting agent;
at least one nozzle that is coupled to the propellant system for receiving and dispensing the firefighting agent;
at least one moveable mount attached to the nozzle having at lease one actuator operatively coupled to the moveable mount, the moveable mount operable to move in a horizontal and vertical manner;
a control unit having a processor, the processor being coupled to the propellant system configured to autonomously control the firefighting device by activating the propellant system to discharge the firefighting agent through the nozzle to a portion of an operational region of the firefighting device based on analysis of sensor data obtained for a portion of the operational region or an adjacent area outside of the operational region or receipt of a signal from another device and the processor being communicatively coupled to the at least one actuator to send an actuator control signal to move the moveable mount and the nozzle according to a movement pattern.

2. The device of claim 1, wherein the housing comprises surfaces that are made of fire-retardant material, are covered by fire retardant fabric or are covered by a fire retardant coating.

3. The device of claim 1, wherein the device further comprises:
a memory for storing program instructions for one or more control programs; and
at least one environmental sensor for measuring environmental data for the operational region; a
wherein the processor, upon executing the one or more control programs, is configured to generate and send the control signal to deploy the firefighting agent when the measured environmental data exceeds a predetermined data threshold based on analysis performed by the processor or analysis performed by a drone.

4. The device of claim 3, wherein the tom at least one environmental sensor is mounted on a portion of the nozzle or another portion of the firefighting device.

5. (canceled)

6. (canceled)

7. The device of claim 3, wherein the at least one environmental sensor includes a temperature measuring temperature data, and the movement pattern is selected from stored predetermined movement patterns based on a characteristic of the fire including a hottest region of a fire, a leading edge of fire growth, a location that the fire is moving towards, an area where there is a fire fuel source and/or an area of fastest movement of the fire.

8. The device of claim 3, wherein the at least one environmental sensor includes a temperature sensor for measuring temperature data. and the movement pattern is selected by performing correlations between the stored predetermined movement patterns and locations of the hottest regions of the fire to select the predetermined movement pattern that has a highest correlation with the locations of the hottest regions of the fire.

9. (canceled)

10. The device of claim 8, wherein the device further comprises communication hardware that is communicatively coupled to the processor and the processor is configured to transmit the measured temperatures to a remote computing device for monitoring any fires in the proximal region.

11. The device of claim 10, wherein the device further comprises a camera that is communicatively coupled to the processor, wherein the processor is configured to obtain images of the operational region and/or a farther adjacent region to the operational region, and transmit the images to the remote computing device.

12. (canceled)

13. (canceled)

14. The device of claim 1, wherein the device further comprises a positioning unit that is communicatively coupled to the processor and is configured to determine a location of the device, and the processor is configured to transmit the location of the device to the remote computing device.

15. The device of claim 3, wherein the at least one environmental sensor includes a wind sensor that is communicatively coupled to the processor and is configured for measuring wind direction and/or wind magnitude data for the operational region and/or a farther adjacent region to the operational region, wherein the processor is configured to transmit the wind direction and/or wind magnitude data to the remote computing device.

16. The device of claim 15, wherein the processor is configured to adjust an output setting of the nozzle to widen or narrow a spray pattern for the firefighting agent based on the measured wind direction and/or wind magnitude data.

17. The device of claim 3, wherein the at least one environmental sensor includes an air quality sensor meter that is communicatively coupled to the processor and is configured for measuring air quality data for the operational region and/or a farther adjacent region to the operational region, wherein the processor is configured to transmit the quality data to the remote computing device.

18. The device of claim 1, wherein the housing comprises one or more panels made of steel and having a fire-retardant coating and/or one or more panels made of fire rated fire resistant porous cement, ceramic boards or carbon-fiber.

19. The device of claim 18, wherein the one or more panels are removably mounted to the housing to allow for maintenance or replacement of a given panel that has been damaged.

20. (canceled)

21. The device of claim 1, wherein the device further comprises a cover that is operatively mounted to the housing, the cover being extendable from a closed position to an open position in which the cover is extended to the ground and is adjacent to upper and side portions of the device to provide an enclosure for at least one person for protection from fire.

22. (canceled)

23. (canceled)

24. The device of claim 21, wherein the device further comprises at least two nozzles that are coupled to the propellant system for receiving and deploying the firefighting agent.

25. The device of claim 24, wherein the device comprises doors disposed at a top surface of the housing, an additional actuator for moving the additional nozzle and a valve between the additional nozzle and the propellant system and the additional nozzle has a storage position where it is disposed under the doors and an operating position when the doors are opened, the additional actuator being configured to raise the additional nozzle above the top surface of the housing and the valve is opened to allow the firefighting agent to travel to the additional nozzle.

26. The device of claim 21, wherein the device further comprises a sensor that is configured to detect when the cover is deployed and the device is configured to generate an alert signal when the cover is deployed and transmit the alert signal to a remote device including a command center device, and/or a mobile device of a firefighter.

27. The device of claim 26, wherein the device is configured to send a location signal to the remote device to provide a location of the device when the cover is deployed.

28. The device of claim 1, wherein the firefighting agent comprises any fire retardant material.

29. (canceled)

30. (canceled)

31. (canceled)

32. (canceled)

33. (canceled)

34. The device of claim 1, wherein the device further includes a drone that is deployed during use for providing surveillance of the operational region and/or a farther adjacent region of the device or a control signal to the device for automated deployment of the firefighting agent.

35. The device of claim 34, wherein the device includes bay doors on a portion of the housing for allowing the drone to lift-off and land and a mount located within the housing for storing the drone.

36. The device of claim 35, wherein the device includes a first interior frame that is coupled to the housing, a second interior frame that is pivotally connected to the first interior frame for pivoting about a first horizontal axis and a mount that is pivotally connected to the second interior frame for pivoting about a second horizontal axis that is perpendicular to the first pivot axis where the mount provides a surface for housing the drone such that the drone is horizontally level after deployment of the device.

37. The device of claim 34, wherein the drone is configured to obtain image data, analyze the image data to determine a location of a fire in the operational region and send the control signal to the device to deploy the firefighting agent to the location of the fire in the operation region.

38. The device of claim 34, wherein the drone is configured to obtain image data, analyze the image data to determine a location of operational region that a fire front is moving towards and send the control signal to the device to deploy the firefighting agent to the location of the operational region that the fire front is moving towards.

39. The device of claim 34, wherein the drone is configured to send data to the device and the device is configured to adjust a position of the nozzle during use based on the data from the drone.

40. The device of claim 34, wherein the drone is configured to send data to a remote operator and the device is configured to receive control signals from the remote operator to adjust a position of the nozzle during use.

41. The device of claim 1, wherein the device comprises:
an outer frame upon which the housing is mounted; and
a suspension assembly that is coupled with the outer frame to provide shock absorption when the device is deployed or when the device experiences an impact during use.

42. The device of claim 41, wherein the suspension assembly comprises a set of shock absorbers that are disposed within leg frames of the outer frame, the shock absorbers each having one end coupled to the outer frame and another end coupled to leg posts that slidably move in the leg frame.

43. The device of claim 42, wherein the leg posts have a slot that is engaged by a post connected to the leg frames for limiting a linear range of motion for the leg post.

44. The device of claim 41, wherein the device comprises feet that are pivotally connected at a lower portion of the leg posts.

45. The device of claim 1, wherein the device comprises quick connect couplings for the at least one tank and the propellant system to allow for quick refiling of source material for the firefighting agent and a compressed gas used by the propellant system.

46. The device of claim 1, wherein the device comprises quick connect couplings to connect the at least one tank to an exterior source that provides source material for the firefighting agent during deployment of the firefighting agent.

47. The device of claim 1, wherein the device further comprises at least one additional nozzle that is mounted at a first lateral side wall, a second lateral side wall and/or a rear wall, wherein the at least one additional nozzle is coupled to the propellant system and the at least one tank via a multi-port valve that is controllable to selectively provide the firefighting agent to the at least one additional nozzle that is oriented towards a direction of the fire.

48. The device of claim 1, wherein the device is operable in one of an autonomous mode, a remote control mode and/or a manual control mode, wherein during the remote control mode and the manual control mode control signals are provided by a human operator.

49. (canceled)

50. A method for operating a firefighting device defined according to claim 1, wherein the method comprises:
measuring environmental data of a portion of an operational region or a farther adjacent region to the portion of the operational region of the firefighting device;
comparing the measured environmental data to a data threshold; and
autonomously discharging the firefighting agent from the nozzle of the firefighting device towards the portion of the operating region when the measured environmental data exceeds the data threshold.

51. The method of claim 50, wherein the method comprises moving the nozzle in a vertical and/or horizontal manner during discharge of the firefighting agent.

52. The method of claim 50, wherein the method comprises measuring temperature and determining a hottest area of a fire in the proximal region from temperature data of the proximal region controlling movement of the nozzle so that a tip of the nozzle is directed to the hottest area of the fire.

53. The method of claim 50, wherein the method comprises measuring temperature and determining when there is a fire in the operational region based on temperature data of the operational region, selecting a movement pattern for the nozzle, and moving a tip of the nozzle according to the selected movement pattern.

54. The method of claim 53, wherein the movement pattern is selected from a plurality of stored predetermined movement patterns based on a characteristic of the fire including a hottest region of a fire, a leading edge of fire growth, a location that the fire is moving towards, an area where there is a fire fuel source and/or an area of fastest movement of the fire.

55. The method of claim 53, wherein the movement pattern is selected by performing correlations between stored predetermined movement patterns and locations of the hottest regions of the fire to select the stored predetermined movement pattern that has a highest correlation with the locations of the hottest regions of the fire.

56. The method of claim 50, wherein the method comprises monitoring the operation of the firefighting device at a remote computing device.

57. The method of claim 56, wherein the method comprises storing and/or transmitting the measured environmental data to the remote computing device.

58. The method of claim 56, wherein the method comprises obtaining images of the operational region and/or the farther adjacent region, and storing and/or transmitting the images to the remote computing device.

59. The method of claim 56, wherein the method comprises determining a location of the firefighting device and storing and/or transmitting the location to the remote computing device.

60. The method of claim 56, wherein the method comprises measuring wind direction and/or wind magnitude data for the operational region and/or the farther adjacent region, and storing and/or transmitting the wind direction and/or wind magnitude data to the remote computing device.

61. The method of claim 56, wherein the method comprises measuring air quality data for the operational region and/or the farther adjacent region, and storing and/or transmitting the air quality data to the remote computing device.

62. A system for fighting fire in a region, wherein the system comprises;
a plurality of firefighting devices that are defined according to claim 1;
a remote computing device that comprises:
a memory for storing program instructions for a firefighting monitor/control program;
communications hardware for receiving data from the plurality of firefighting devices;
a processor that is communicatively coupled to the memory and the transceiver, the processor when executing the software instructions being configured to receive and display the data received from the plurality of firefighting devices.

63. The system of claim 62, wherein the processor is configured to generate a map of the region and display at least some of the data received from the plurality of firefighting devices on the map or from drones associated with the firefighting devices.

64. The system of claim 63, wherein the data comprises location data and the processor is configured to generate the map of the region including the locations of the plurality of firefighting devices.

65. The system of claim 64, wherein the data comprises temperature data and the processor is configured to generate the map of the region including the temperature data at the locations of the plurality of firefighting devices.

66. The system of claim 64, wherein the data comprises wind direction and wind magnitude data and the processor is configured to generate the map of the region including the wind direction and wind magnitude data at the locations of the plurality of firefighting devices.

67. The system of claim 64, wherein the data comprises air quality data and the processor is configured to generate the map of the region including the air quality data at the locations of the plurality of firefighting devices.

68. The system of claim 64, wherein the data is received periodically and the processor is configured to update the generated map of the region with the periodically received data.

69. The system of claim 64, wherein the data is received in real time and the processor is configured to update the generated map of the region with the received data in real time.
